(19) United States
(12) Patent Application Publication
(10) Pub. No.: US 2026/0205418 A1
(43) Pub. Date: Jul. 16, 2026

(54) SYSTEMS AND METHODS FOR MANAGING UNDESIRED COMMUNICATION TRAFFIC

(71) Applicant: Cable Television Laboratories, Inc., Louisville, CO (US)

(72) Inventors: Kyle Haefner, Fort Collins, CO (US); Craig M. Pratt, Portland, OR (US); Randy Levensalor, Boulder, CO (US)

(21) Appl. No.: 19/447,898

(22) Filed: Jan. 13, 2026

Related U.S. Application Data
(60) Provisional application No. 63/744,705, filed on Jan. 13, 2025.

(51) Int. Cl. H04L 47/24; H04L 9/40

(52) U.S. Cl. CPC H04L 47/24; H04L 63/0428

(57) ABSTRACT

A method operable by a gateway for managing undesired communication traffic includes (i) receiving a traffic fingerprint from a management controller, the traffic fingerprint representing one or more characteristics of the undesired communication traffic, (ii) comparing the traffic fingerprint to a connection log of the gateway to determine that the undesired communication traffic corresponds to a first communication traffic flow, the first communication traffic flow being a communication traffic flow of a first client of a local area network (LAN) that flows through the gateway, and (iii) in response to determining that the undesired communication traffic corresponds to the first communication traffic flow, managing the first communication traffic flow according to one or more filtering rules without interfering with a second communication traffic flow, the second communication traffic flow being another communication traffic flow of the first client of the LAN that flows through the gateway.

### RELATED APPLICATIONS

This application claims benefit of United States Provisional Patent Application Number 63/744,705, filed on January 13, 2025, which is incorporated herein by reference. The following documents are also incorporated herein by reference: (i) U.S. Patent No. 11,115,289, issued on September 7, 2021, entitled “SYSTEMS AND METHODS FOR NETWORK SECURITY MODEL,” (ii) U.S. Patent No. 11,848,827, issued on December 19, 2023, entitled “SYSTEMS AND METHODS FOR NETWORK SECURITY MODEL,” (iii) U.S. Patent No. 11,611,532, issued on March 21, 2023, entitled “SYSTEMS AND METHODS FOR NETWORK SECURITY MODEL,” (iv) U.S. Patent No. 12,267,297, issued on April 1, 2025, entitled “SYSTEMS AND METHODS FOR NETWORK SECURITY MODEL,” (v) U.S. Patent Application Publication No. 2025/0317418, published on October 9, 2025, entitled “SYSTEMS AND METHODS FOR NETWORK SECURITY MODEL,” (vi) U.S. Patent Application No. 18/775,280, filed on July 17, 2024, entitled “SYSTEMS AND METHOD FOR ATTRIBUTE-BASED MICRONETS,” (vii) U.S. Provisional Patent Application No. 63/438,587, filed on January 12, 2023, entitled “DISTRIBUTED FIREWALL FOR NEXT GENERATION ACCESS NETWORKS,” and (viii) U.S. Patent Application Publication No. 2020/0021490, published on January 16, 2020, entitled “SYSTEMS AND METHODS FOR ADVANCED CORE NETWORK CONTROLS.”

### BACKGROUND

Undesired communication traffic from malware, botnets, distributed denial of service attacks (DDoS), etc. consumes uplink and downlink communication network capacity. Additionally, the following three communication network initiatives may increase costs or impact of undesired communication traffic: (1) symmetric communication service which increases uplink bandwidth, possibly over 20 times, relative to asymmetric communication service, e.g., by increasing uplink bandwidth from 40 megabits per second (Mbps) to 1 Gigabit per second (Gbps), (2) gigabit and 10 Gbps communication service which dramatically increases bandwidth overall, and (3) low latency. Moreover, the aforementioned initiatives may increase the value of subscribers’ homes and businesses for cybercrime. For example, homes with high bandwidth or low latency uplinks may be very attractive targets for botnets, and homes with high bandwidth or low latency uplinks may be more useful for crypto currency mining and illicit content servers than homes with low bandwidth and high latency uplinks.

### SUMMARY

In an embodiment, a method operable by a gateway for managing undesired communication traffic, where the gateway communicatively couples a local area network (LAN) with a communication service provider's network, includes the following steps: (1) receiving a traffic fingerprint from a management controller, the traffic fingerprint representing one or more characteristics of the undesired communication traffic, (2) comparing the traffic fingerprint to a connection log of the gateway to determine that the undesired communication traffic corresponds to a first communication traffic flow, the first communication traffic flow being a communication traffic flow of a first client of the LAN that flows through the gateway, and (3) in response to determining that the undesired communication traffic corresponds to the first communication traffic flow, managing the first communication traffic flow according to one or more filtering rules without interfering with a second communication traffic flow, the second communication traffic flow being another communication traffic flow of the first client of the LAN that flows through the gateway.

In an embodiment, a method operable by a gateway for managing undesired communication traffic, where the gateway communicatively couples a LAN with a communication service provider's network, includes the following steps: (1) receiving a traffic fingerprint from a management controller, the traffic fingerprint representing one or more characteristics of the undesired communication traffic, (2) comparing the traffic fingerprint to each uplink data packet flowing through the gateway, and (3) managing each uplink data packet flowing through the gateway that matches the traffic fingerprint according to one or more filtering rules, without interfering with uplink data packets flowing through the gateway that do not match the traffic fingerprint.

In an embodiment, a method operable by a gateway for managing undesired communication traffic, where the gateway communicatively couples a LAN with a communication service provider's network, includes the following steps: (1) receiving a machine learning model from a management controller, (2) receiving, from the management controller, one or more updated weights for the machine learning model, (3) updating the machine learning model at least partially using the one or more updated weights, (4) after updating the machine learning model, using the machine learning model to classify communication traffic flowing through the gateway as either desired or undesired, and (5) managing communication traffic flowing through the gateway that is classified as undesired according to one or more filtering rules, without interfering communication traffic flowing through the gateway that is classified as desired.

In an embodiment, a method operable by a management controller for managing undesired communication traffic originating from a LAN, where the LAN is communicatively coupled to a communication service provider's network by a gateway, includes the following steps: (1) receiving metadata for the undesired communication traffic, (2) detecting communication traffic in the communication service provider's network matching the metadata, (3) determining that the gateway is a source of the communication traffic in the communication service provider's network matching the metadata, (4) in response to determining that the gateway is the source of the communication traffic in the communication service provider's network matching the metadata, generating a traffic fingerprint representing one or more characteristics of the communication traffic in the communication service provider's network matching the metadata, and (5) sending the traffic fingerprint to the gateway at least partially using the communication service provider's network.

In an embodiment, a method operable by a controller for managing undesired communication traffic originating from a LAN, where the LAN is communicatively coupled to a communication service provider's network by a gateway, includes the following steps: (1) receiving metadata for the undesired communication traffic, (2) detecting communication traffic in the communication service provider's network matching the metadata, (3) determining that the gateway is a source of the communication traffic of the communication service provider's network matching the metadata, (4) in response to determining that the gateway is the source of communication traffic of the communication service provider's network matching the metadata, generating updated weights for a machine learning model of the gateway at least partially based on the metadata, the machine learning model of the gateway being capable of classifying communication traffic flowing through the gateway as either desired communication traffic or undesired communication traffic, and (5) sending the updated weights to the gateway at least partially using the communication service provider's network.

In an embodiment, a method operable by a first network element for managing undesired communication traffic includes the following steps: (1) receiving one or more data packets including first in-band telemetry data, (2) verifying authenticity of the first in-band telemetry data using a digital signature, and (3) managing the one or more data packets at the first network element in accordance with one or more filtering rules.

### BRIEF DESCRIPTION OF THE DRAWINGS

FIG. 1 is a schematic diagram of a communication environment including a system for managing undesired communication traffic, according to an embodiment.

FIG. 2 is a dataflow diagram illustrating one example of a gateway subscribing to management service provided by a management controller.

FIGS. 3A and 3B are collectively a dataflow diagram illustrating one example of identifying a distributed denial of service (DDoS) communication traffic flow by comparing a traffic fingerprint to a connection log.

FIG. 4 is an illustration of an example network address translation (NAT) table.

FIGS. 5A, 5B, and 5C are collectively a dataflow diagram illustrating one example of identifying a Command and Control (C2) communication traffic flow by comparing a traffic fingerprint to a connection log.

FIGS. 6A and 6B are collectively a dataflow diagram illustrating one example of identifying DDOS communication traffic by comparing a traffic fingerprint to each data packet passing through a gateway.

FIG. 7 is a dataflow diagram illustrating one example of a gateway identifying a DDoS communication traffic flow using a machine learning model.

FIG. 8 is a schematic diagram of an alternate embodiment of the FIG. 1 communication environment including additional filtering points.

FIGS. 9A and 9B are collectively a dataflow diagram illustrating one example of use of in-band telemetry data in the FIG. 8 communication environment.

### DEFINITIONS

The following are definitions of certain terms used in this document:

(a) Traffic Fingerprint: one or more characteristics of undesired communication traffic. Examples of a traffic fingerprint include, but are not limited to, one or more of (i) communication traffic flow parameters, such as source Internet Protocol (IP) address, destination IP address, source port identity, source port type, destination port identity, and/or destination port type, (ii) communication payload data, such as patterns and/or byte sequences within data packet payloads, (iii) communication traffic flow characteristics, such as timing and/or spacing between data packets in a traffic flow.

(b) Filtering Point: a point in a communication network that can enforce, apply, and/or implement filtering rules for communication traffic of devices downstream of the filtering point. A filtering point can pull rules, and/or be pushed rules, from a filtering manager or an analogous service. A filtering point is optionally capable of considering one or more of (i) metadata associated with a downstream device and (ii) communication traffic from the downstream device, when enforcing, applying, and/or implementing filtering rules.

(c) Filtering Rule: instructions to manage communication traffic at a filtering point in response to matching the communication traffic to a traffic fingerprint. Examples of filtering rules include, but are not limited to, one or more of (i) impeding communication traffic matching a traffic fingerprint, such as by blocking the communication traffic, black-holing the communication traffic, or delaying the communication traffic, (ii) tagging communication traffic matching a traffic fingerprint, such as by adding in-band telemetry data to the communication traffic, (iii) redirecting communication traffic matching a traffic fingerprint, (iv) mirroring communication traffic matching a traffic fingerprint, (v) storing communication traffic matching a traffic fingerprint, and (vi) logging communication traffic matching a traffic fingerprint.

(d) Match-Action Policy: a policy that is a function of metadata, such as metadata of a filtering point. Examples of metadata that may affect a match-action policy include, but are not limited to, one or more (i) identification of a type of a filtering point, (ii) identification of a category of a filtering point, (iii) identification of a service performed a filtering point, (iv) identification of an internal micronet that a filtering point supports, (v) identification of a virtual local area network (VLAN) that a filtering point supports, (vi) identification of a matter fabric that a filtering point supports, (vii) identification of a protocol used by a filtering point, (viii) identification of a vendor of a filtering point, and (ix) a device identifier of a filtering point.

(e) P4: short for “Programming Protocol-Independent Packet Processors,” which is a programming language designed for programming of packet forwarding planes.

(f) Communication Traffic Flow: a sequence of data packets where each data packet has the same tuple, i.e., source address, destination address, source port, and destination port.

### DETAILED DESCRIPTION OF THE EMBODIMENTS

It is conventionally difficult for a communication service provider to manage, e.g., block, undesired communication traffic originating from a subscriber’s premises, such as distributed denial of service (DDoS) communication traffic or Command and Control (C2) communication traffic. For example, a communication service provider may need to contact the subscriber and describe what is happening, why it is happening, how it affects the subscriber’s service, and how to find an infected client on the subscriber’s local area network (LAN), to manage undesired communication traffic from the subscriber’s premises. Additionally, the subscriber may lack technical skills and tools needed to mitigate the infected client, and the provider’s ability to assist the subscriber may be impaired by lack of visibility into the subscriber’s LAN. Furthermore, subscriber privacy may be compromised by need for the subscriber to disclose identity of clients on the subscriber’s LAN to enable the provider to assist the subscriber in eradicating the infected client.

In view of the aforementioned difficulties, a communication service provider may elect to restrict communication service of a subscriber in response to the subscriber’s premises generating undesired communication traffic. For example, the communication service provider may limit the subscriber’s communication service to a walled garden which restricts the subscriber’s access to the broader Internet while allowing the subscriber to access to a limited set of resources, such as a remediation portal or a self-help page. While restricting a subscriber’s communication service is typically effective in stopping undesired communication traffic originating from the subscriber, such restriction may significantly inconvenience the subscriber and create customer support difficulties from the communication service provider.

Disclosed herein are new systems and methods for managing undesired communication traffic which at least partially overcome the problems discussed above. Particular embodiments automatically block, or otherwise manage, undesired communication traffic originating from a subscriber’s LAN at one or more filtering points without interfering with desired communication traffic from the subscriber’s LAN. Additionally, certain embodiments promote privacy by operating with minimal subscriber identifiable information, such as without initial knowledge of an Internet Protocol (IP) address of an infected client and/or without sharing an IP address of a victim device. For example, some embodiments empower subscribers with an option to have their gateways automatically alert and block undesired communication traffic at its source without exposing their internal network architecture to their communication service provider. This feature may be increasingly important to the subscribers, as well as to communication service providers, especially as uplink capacities increase. As another example, some embodiments protect a subscriber and the subscriber’s network in a way that preserves the subscriber's privacy by only storing a source IP address and a public key of the subscriber’s gateway, as well as by encrypting details of undesired communication traffic in a way that is only unlockable by the subscriber’s gateway.

Furthermore, some embodiments can manage undesired communication traffic on a large scale. For example, certain embodiments are capable of managing DDoS communication traffic from multiple subscribers that is part of a common DDoS attack by blocking flow of the DDoS communication traffic at a respective gateway of each subscriber, thereby stopping the DDoS communication traffic at multiple source points.

Moreover, particular embodiments leverage a gateway's unique position in a communication environment to track communication traffic flows and to determine internal architecture and clients of a LAN, in cooperation with an external management controller that generates privacy-preserving feeds, e.g., traffic fingerprints, that the gateway can act on. Additionally, some embodiments use verified detection of undesired communication traffic to inform the gateway of rules it should implement. These uses of a gateway may be particularly advantageous in embodiments where the gateway performs network address translation (NAT) because (i) the gateway is the only single device capable of examining communication traffic both before and after NAT, and (ii) the gateway can make decisions, as informed by filtering rules from a management controller, that take into account the internal architecture of the LAN.

Additionally, some embodiments can manage undesired communication traffic at multiple filtering points, e.g., at a gateway of a customer’s premises and at a network element, such as a router, upstream of the customer premises. Furthermore, some embodiments extend the functionality of in-band telemetry data to allow network elements upstream of a gateway to act as filtering points and thereby block undesired communication traffic while not exposing a user's data or an architecture of a user’s LAN behind the gateway. For example, in some embodiments including P4-enabled filtering points, a software defined networking (SDN) controller, such as a management controller, can provide instructions to all, or at least some, of the P4-enabled filtering points to manage a DDoS attack or other undesired communication traffic event. In an exemplary embodiment, the SDN controller further instructs the P4-enabled devices to drop any packet matching the source (e.g., IP address or MAC address) and packet type identified as being a part of a DDoS attack or other undesired communication traffic event. Some embodiments leverage a machine learning based controller of a detection system that is trained with patterns to identify conditions and to perform a number of dynamic operations by deploying new packet processing behaviors in a communication network (e.g., DDoS mitigation, virtual firewall, quality of service (QoS) detection/enforcement, data plane functions, such as Data Over Cable Service Interface Specification (DOCSIS) data plane functions in a cable application, etc.). All operations are optionally performed at line rate and may further leverage P4 In-band Network Telemetry (INT) to allow collection and reporting without control plane intervention. In an exemplary embodiment, inserting telemetry data into packet headers advantageously enables telemetry data on all packets, instead of only taking a sample of the packets.

Moreover, in certain embodiments, a gateway (e.g., a gateway running the Reference Design Kit Broadband (RDKB) software stack) includes a P4-enabled network interface card (NIC). The P4-enabled NIC allows for additional data (e.g., metadata) to be added to the headers of data being transmitted from the gateway to allow for improved telemetry relative to conventional approaches. The gateway can be configured to route data from user network clients to a point of a communication service provider’s network, such as a receive data (RxD) point associated with a hub of the communication service provider’s network. The data may then be routed to P4 switches, which may include, or may be, configurable switches that enable dynamic routing of messages. In an exemplary embodiment, the P4 switches are configured to provide an enhanced platform to support micronets, DDoS identification/mitigation, blocking of infected terminations devices (e.g., cable modems, wireless modems, or optical network terminations (ONTs), full packet capture, network traffic characterization, and/or crypto evolution.

Additionally, in some embodiments, traffic fingerprints of undesired communication traffic are organized into feeds with traffic fingerprints having a priority established by an external detection service. This prioritization can allow resource-limited filtering points to apply their limited filtering resources to achieve the highest impact. For example, a DDoS attack that originates from a small population of subscribers could be handled directly by the subscribers’ respective gateways. In contrast, a larger more damaging attack could be mitigated further in a communication network at one or more filtering points upstream of the gateways using transparent security and/or peering/intermediate routers.

Furthermore, in some embodiments, telemetry data may be requested from, or periodically reported by, one or more devices to a machine learning (ML) driven software defined network. For example, in a DDoS use case, telemetry data may communicate the number of packets to be forwarded to the next stage in the network and/or the number of packets to be blocked, due to the DDoS rule ordered by a previous device/gateway/switch. In certain embodiments, the relevant information may be aggregated and reported to an operator or customer to repair infected devices and/or for future analysis. In certain embodiments, the one or more devices are P4 enabled devices or are one or more other types of programmable devices.

Moreover, some embodiments leverage software and programmable hardware to reduce, or even eliminate, the need for custom hardware for filtering points. For example, certain embodiments leverage programmable application specific integrated circuits (ASICs) and the P4 Runtime to provide enhanced device visibility and packet processing by making data plane behavior expressible in software and customizable without impacting performance. As another example, certain embodiments of the new systems and methods pair a DOCSIS modem, enhanced with a P4 Runtime, with a series of P4-enabled devices connecting back to an operator headend to provide visibility throughout an access communication network.

Additionally, some embodiments are capable of logging and/or tracking undesired communication traffic without necessarily mitigating the undesired communication traffic. Furthermore, some embodiments are configured to notify an end user, such as a subscriber, that their communication traffic is being managed (e.g., blocked) and that a device of the end user may have a security vulnerability and may have been compromised.

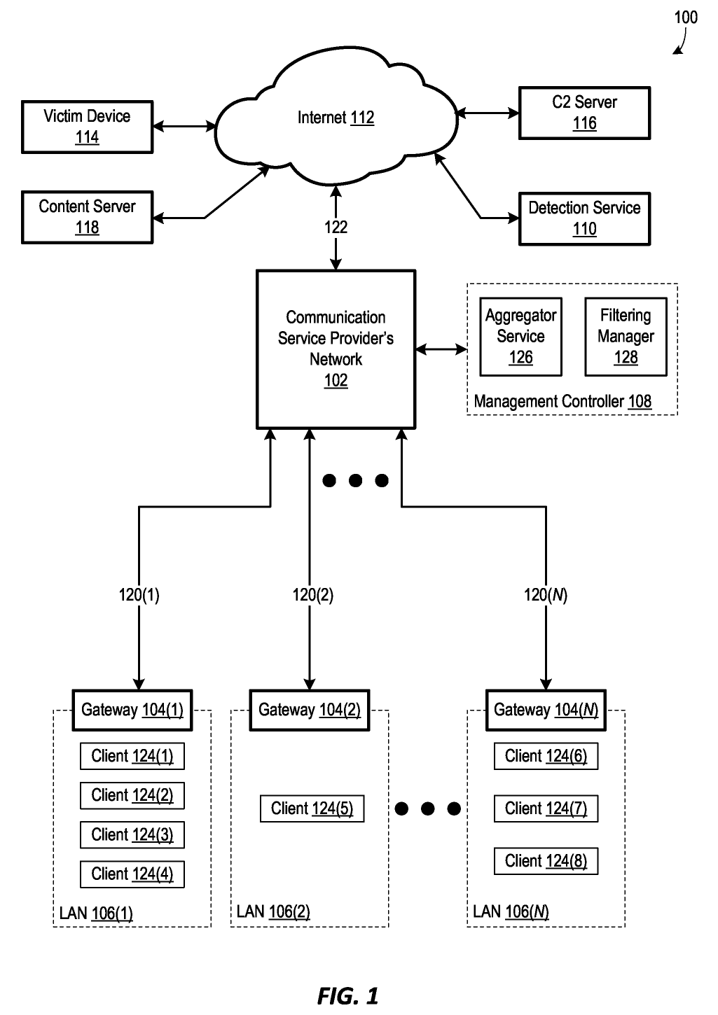

FIG. 1 is a schematic diagram of a communication environment 100 including one embodiment of the new systems for managing undesired communication traffic. Communication environment 100 includes a communication service provider’s network 102, N gateways 104, a respective LAN 106 for each gateway 104, a management controller 108, a detection service 110, the Internet 112, a victim device 114, a C2 server 116, and a content server 118, where N is an integer greater than one. In this document, specific instances of an item may be referred to by use of a numeral in parentheses (e.g. gateway 104(1)) while numerals without parentheses refer to any such item (e.g. gateways 104). N could be a small number such that communication environment 100 includes a small quantity of gateways 104 and corresponding LANs 106, or N could be a large number such that communication environment 100 includes a large quantity, e.g., thousands, tens of thousands, or more, gateways 104 and corresponding LANs 106. As discussed below, management controller 108 and gateways 104 collectively implement one embodiment of the new systems for mitigating undesired communication traffic.

Communication service provider’s network 102 provides communication service for subscribers. In some embodiments, each gateway 104 is associated with a respective subscriber, and each gateway 104 may be located at a respective subscriber’s premises, such as at the subscriber’s home or business. While not required, it is anticipated that communication service provider’s network 102 will include a core network (not shown) and an access network (not shown). In certain embodiments, communication service provider’s network 102 is one or more of (i) a cable communication network, e.g., operating according to a DOCSIS communication protocol, (ii) an optical communication network, e.g., a fiber optic communication network operating according to a passive optical network (PON) communication protocol, a fiber optic communication network operating according to a coherent optics communication protocol, or a free space optical communication network, (iii) a terrestrial wireless communication network, e.g., operating according to a Third Generation Partnership (3GPP) communication protocol or a successor thereof, (iv) a satellite wireless communication network, e.g., using very low earth orbit (VLEO) satellites, low earth orbit (LEO) satellites, medium earth orbit (MEO) satellites, or geostationary equatorial orbit (GEO) satellites, (v) a digital subscriber line (DSL) communication network, and (vi) a powerline communication network.

Communication service provider’s network 102 communicatively couples each gateway 104 to the Internet 112 as symbolically shown by arrows 120 and an arrow 122. Each arrow 120 represents communicative coupling of a respective gateway 104 with communication service provider’s network 102, and arrow 122 represents communicative coupling of communication service provider’s network 102 with the Internet 112. While FIG. 1 illustrates communication service provider’s network 102 being communicatively coupled with gateways 104 in a star topology, FIG. 1 should not be construed to require any particular communication network topology. For example, gateways 104 could be communicatively coupled with communication service provider’s network 102 in a ring topology, a mesh topology, a tree-and-branch topology, etc.

Detection service 110, victim device 114, C2 server 116, and content server 118 are communicatively coupled to the Internet 112. Detection service 110 is configured to detect malicious traffic, or other undesired communication traffic, on communication networks and share attack metadata with communication service providers, such as the communication service operating network 102. Alternately or additionally, one or more communication service providers may provide information on undesired communication traffic that they detected to detection service 110. In some alternate embodiments, detection service 110 is at least partially integrated in management controller 108 and/or in communication service provider’s network 102. Victim device 114 is a non-malicious device that is subject to a DDoS attack, and C2 server 116 is a malicious device that is configured to control a compromised client. Content server 118 is a non-malicious device configured to provide content to clients. Victim device 114, C2 server 116, and content server 118 are included in FIG. 1 to illustrate examples of operation of the new systems and methods, and it understood that the new systems and methods are not limited to use with victim device 114, C2 server 116, and/or content server 118.

Each LAN 106 includes one or more respective clients 124. Examples of clients 124 include, but are not limited to, mobile phones, computers, set-top devices, data storage devices, Internet of Things (IoT) devices, entertainment devices, computer networking devices, smartwatches, wearable devices with wireless capability, medical devices, security devices, monitoring devices, and wireless access devices. Each LAN 106 is, for example, (i) a wireless LAN, such as operating according to an Institute of Electrical and Electronics Engineers (IEEE) 802.11 communication protocol, e.g., a Wi-Fi wireless communication protocol, and/or (ii) a wired LAN, e.g., operating according to an Ethernet communication protocol and/or a home networking communication protocol. Although FIG. 1 illustrates LANs 106(1), 106(2), and 106(N) as including four clients 124, one client 124, and three clients 124, respectively, it is understood that the quantity of clients 124 per LAN 106 may vary. Additionally, in some cases, a given LAN 106 may not include any clients 124. For example, a LAN 106 may not include any clients 124 when the LAN 106 is initially configured. As another example, a LAN 106 may not include any clients 124 at a given time if all clients 124 of the LAN 106 are mobile clients that are currently away from the LAN 106.

Each gateway 104 is configured to communicatively couple its respective LAN 106 with communication service provider’s network 102. In some embodiments, each gateway 104 includes a respective modem (e.g., a cable modem, a wireless modem, a DSL modem, etc.), or a respective ONT, that is configured to communicatively couple clients 124 of its respective LAN 106 to communication service provider’s network 102. Accordingly, in some embodiments, gateways 104 may alternately be referred to as modems or ONTs. Additionally, in some embodiments, at least one gateway 104 is configured to perform one or more functions of its respective LAN 106, such that the gateway 104 and its respective LAN 106 are partially combined. For example, in certain embodiments, at least one gateway 104 is configured to assign IP addresses to clients 124 of its corresponding LAN 106, such according to a Dynamic Host Configuration Protocol (DHCP). As another example, in some embodiments, at least one gateway 104 is configured to perform Network Address Translation (NAT) to enable all clients 124 of its respective LAN 106 to share a common public IP address. As a further example, in some embodiments, at least one gateway 104 includes hardware, such as one or more communication transceivers, of its respective LAN 106. While each gateway 104 is depicted as being a single device, the constituent elements of each gateway 104 need not be co-packaged. Additionally, in some embodiments, at least one gateway 104 uses remote computing and/or storage resources, such as cloud computing and/or storage resources, that are accessible to the gateway 104 via communication service provider’s network 102.

Management controller 108 includes an aggregator service 126 and a filtering manager 128. Aggregator service 126 is configured to manage subscription of gateways 104 to a management service provided by management controller 108, as well as to serve as a point of contact for filtering points to management controller 108. In some embodiments, aggregator service 126 tracks subscribing gateways 104 solely using a public key of the gateway 104 and an IP address of the gateway 104. It should be noted that this method of tracking subscribing gateways 104 minimizes need for management controller 108 to handle sensitive subscriber information. For example, aggregator service 126 does not necessarily need to know a name or an account number of a subscriber associated with a subscribing gateway 104. As another example, aggregator service 126 does not necessarily need to know details of the subscribing gateway 104, such as a media access control (MAC) address of the subscribing gateway 104 or a make and model of the subscribing gateway 104. Such minimization of need for aggregator service 126 to handle sensitive subscriber information advantageously promotes subscriber privacy and security.

Once a given gateway 104 has subscribed to management service of management controller 108, aggregator service 126 notifies the gateway 104 of undesired communication traffic associated with the gateway 104’s respective LAN 106. For example, aggregator service 126 may be configured to (i) match undesired communication traffic, as identified by metadata received from detection service 110, to a gateway 104, (ii) create a traffic fingerprint of or more characteristics of the undesired communication traffic to enable the gateway 104 to identify the undesired communication traffic, and (iii) send the traffic fingerprint to the gateway 104 for the gateway to act on in accordance with filtering rules. In some embodiments, aggregator service 126 is configured to encrypt the traffic fingerprint, such as by using a public key of the gateway 104, before sending the traffic fingerprint to the gateway 104, and the gateway subsequently decrypts the traffic fingerprint using its private key. Alternately or additionally, aggregator service 126 may send proactively send a traffic fingerprint to a given gateway 104 corresponding to a known attack vector even if the gateway 104 is not currently a known source of undesired communication traffic.

Filtering manager 128 is configured to (i) collate instances of undesired communication traffic as detected by detection service 110 and (ii) provide filtering rules to filtering points, such as to instruct the filtering points on how to manage undesired communication traffic matching a traffic fingerprint. In some embodiments, aggregator service 126 and filtering manager 128 are implemented by one or more processors executing instructions, such as in the form of software and/or firmware, stored in one or more data stores. While aggregator service 126 and filtering manager 128 are depicted as being separate elements, aggregator service 126 and filtering manager 128 could alternately be partially or fully combined. Additionally, while management controller 108 is depicted as being a discrete element that is in direct communication with communication service provider’s network 102, the relationship between management controller 108 and other elements of communication environment 100 may vary as long as management controller 108 is capable of performing its functions as described herein. For example, management controller 108 could be partially or fully integrated with communication service provider’s network 102. As another example, management controller 108 could be accessible to communication service provider’s network 102 solely via the Internet 112. As an additional example, at least some portions of management controller 108 could be distributed among gateways 104. Furthermore, the elements of management controller 108 need not be collocated. For example, aggregator service 126 and filtering manager 128 could be implemented in different respective host systems.

Each gateway 104 is configured to operate as a filtering point by cooperating with management controller 108 to manage undesired communication traffic originating from its respective LAN 106. For example, in some embodiments, each gateway 104 subscribes to a management service provided by management controller 108, and in response thereto, filtering manager 128 of management controller 108 provides filtering rules to the gateway 104. In some embodiments, at least one gateway 104 supports P4, and filtering manager 128 provides filtering rules to the gateway 104 in the form of P4 instructions. Additionally, aggregator service 126 may be configured to push a traffic fingerprint to a gateway 104, such as in response to aggregator service 126 detecting undesired communication traffic flowing from the gateway 104. Alternately or additionally, each gateway 104 may be configured to pull a traffic fingerprint from aggregator service 126, such as according to a predetermined schedule and/or in response to a detected security issue in the gateway 104’s respective LAN 106. Furthermore, in some embodiments, one or more gateways 104 at least partially use remote computing resources, such as cloud computing resources and/or computing resources of communication service provider’s network 102, to implement filtering rules.

Each traffic fingerprint received by a given gateway 104 from filtering manager 128 includes one or more characteristics of undesired communication traffic flowing through the gateway from a client of a respective LAN 106. A gateway 104 receiving a traffic fingerprint identifies undesired communication traffic flowing through the gateway 104 by matching the traffic fingerprint to the communication traffic. A gateway 104 may match a traffic fingerprint to communication traffic flowing through the gateway, for example, by (i) comparing the traffic fingerprint to a connection log of the gateway 104, such as a NAT connection table of the gateway 104, and identifying a traffic flow listed in the log that matches the traffic fingerprint, (ii) matching absolute bit offset within one or more data packets of communication traffic with the traffic fingerprint, (iii) matching relative bit offset within one or more data packets of communication traffic with the traffic fingerprint, or (iv) matching a pattern of payload data of communication traffic with the traffic fingerprint. In some embodiments, one or more gateways 104 determine whether a traffic fingerprint matches communication traffic flowing through the gateway 104 on one or more of the following basis: (i) equality, (ii) inequality, e.g., greater than or less than, and (iii) fuzzy matching. Additionally, in some embodiments, a gateway 104 may match a traffic fingerprint to undesired communication traffic newly flowing through the gateway 104 if the traffic fingerprint includes characteristics of a known attack vector corresponding to the undesired communication traffic.

Once a gateway 104 identifies undesired communication traffic by matching a traffic fingerprint to communication traffic flowing through the gateway, the gateway 104 may manage the undesired communication traffic according to the filtering rules received from filtering manager 128. For example, the gateway 104 may impede the undesired communication traffic, such as by blocking the undesired communication traffic, black-holing the undesired communication traffic, or delaying the undesired communication traffic, without interfering with other communication traffic of the LAN 106. As another example, the gateway 104 may log the undesired communication traffic. As an additional example, the gateway 104 may tag the undesired communication traffic by adding in-band telemetry data to the undesired communication network, such as to enable a device (not shown) of communication service provider’s network 102 to identify and manage the undesired communication traffic. As a further example, the gateway 104 may redirect, mirror, store, or copy the undesired communication traffic.

Additionally, in some embodiments, filtering manager 128 and/or a given gateway 104 can chose which filtering rules to implement, such as in cases where the gateway 104 does not have sufficient resources to enforce all filtering rules, or when enforcing all filtering rules would degrade subscriber service. For example, filtering manager 128 and/or a given gateway 104 may select one or more filtering rules to enforce based on a heuristic rule such as (i) enforce filtering rules associated with last seen undesired communication traffic, (ii) do not enforce filtering rules associated with least frequently seen undesired communication traffic, or (iii) do not enforce one or more oldest filtering rules. Alternately or additionally, filtering manager 128 and/or or a given gateway 104 may apply an algorithm to merge one or more similar filtering rules together, such as to reduce the quantity of filtering rules to enforce. Additionally, filtering manager 128 or a gateway 104 can apply machine learning to determine which filtering rules to enforce, such as by training a machine learning model to only enforce filtering rules that achieve one or more predetermined outcomes.

Furthermore, in some embodiments, one or more filtering points, e.g., a gateway 104 or a network element upstream of gateways 104, receives a match-action policy from filtering manager 128 to supplement filtering rules that it receives from filtering manager 128. A filtering point receiving a match-action policy may manage undesired communication traffic as a function of metadata of the filtering pint, or metadata of a downstream network element, e.g., a client 124, as specified by the match-action policy, as well according to filtering rules. For example, a match-action policy may specify that gateway 104(1) (i) block or black-hole undesired communication traffic of a client 124 if metadata indicates that the client 124 has a verified and unpatched security vulnerability and (ii) generate an alert that undesired communication traffic has been detected and/or log the undesired communication traffic, without interfering with the undesired communication traffic, if metadata does not indicate that the client has a verified and unpatched security vulnerability.

Discussed below are several examples of operation of communication environment 100 and alternate embodiments hereof. However, it is understood that the communication environments may operate in other manners. Additionally, while the examples below are discussed with respect to gateway 104(1), it is understood that the examples below could be adapted to other gateways 104. Furthermore, although the examples below are discussed with respect to version 4 IP addresses, it is understood that the examples below could be adapted to other forms of IP addresses, such as version 6 IP addresses or successors thereof. Moreover, while the examples below are discussed with respect to user datagram protocol (UDP) ports, the examples could be adapted to other types of ports, such as transmission control protocol (TCP) ports.

### Example A – Subscribing to Mitigation Service

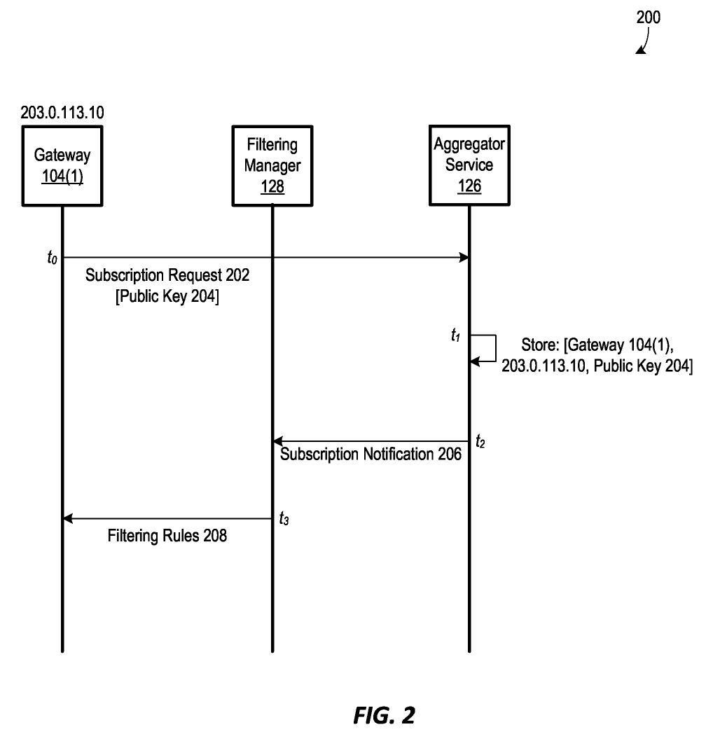

FIG. 2 is a dataflow diagram 200 illustrating one example of gateway 104(1) subscribing to management service provided by management controller 108. FIG. 2 includes vertical lines logically representing each of gateway 104(1), aggregator service 126, and filtering manager 128, and gateway 104(1) is assumed to have public IP address 203.0.133.10. At a time t 0, gateway 104(1) sends a subscription request 202 to aggregator service 126 to subscribe to management service of management controller 108. Subscription request 202 includes a public key 204 of gateway 104(1). In some embodiments, gateway 104(1) establishes a public key infrastructure (PKI) chain of trust with management controller 108 before sending subscription request 202 to aggregator service 126. At a time t 1, aggregator service 126 processes subscription request 202 and creates a subscription for gateway 104(1) by storing gateway 104(1)’s IP address and public key 204 as attributes of gateway 104(1). As such, gateway 104(1) is tracked by management controller 108 solely using its IP address and public key 204, thereby eliminating the need for management controller 108 to store sensitive information associated with gateway 104(1). However, management controller 108 could instead be configured to store alternative and/or additional information to track gateway 104(1)’s subscription without departing from the scope hereof.

At a time t₂, aggregator service 126 sends filtering manager 128 a subscription notification 206 notifying filtering manager 128 that a gateway at IP address 203.0.113.10 has subscribed to management service of management controller 108. Filtering manager 128 responds to subscription notification 206 at a time t₃ by sending filtering rules 208 to gateway 104(1), where filtering rules 208 include one or more filtering rules for future use by gateway 104(1). In some embodiments, filtering rules 208 include, or are supplemented by, a match-action policy (not shown) to adapt filtering rules 208 to metadata associated with gateway 104(1). Alternately or additionally, filtering manager 128 may send filtering rules 208 to gateway 104(1) at one or more other times, such as in response to detection of undesired communication traffic from gateway 104(1), in accordance with a periodic schedule, and/or in response to a request from gateway 104(1). In certain embodiments, gateway 104(1) is configured to include its public key 204 in a request to filtering manager 128 for filtering rules, and filtering manager 128 is configured to look up filtering rules appropriate for gateway 104(1) based on an index of gateway 104(1)’s public key 204.

### Example B – Connection Log Matching Using a Traffic Fingerprint

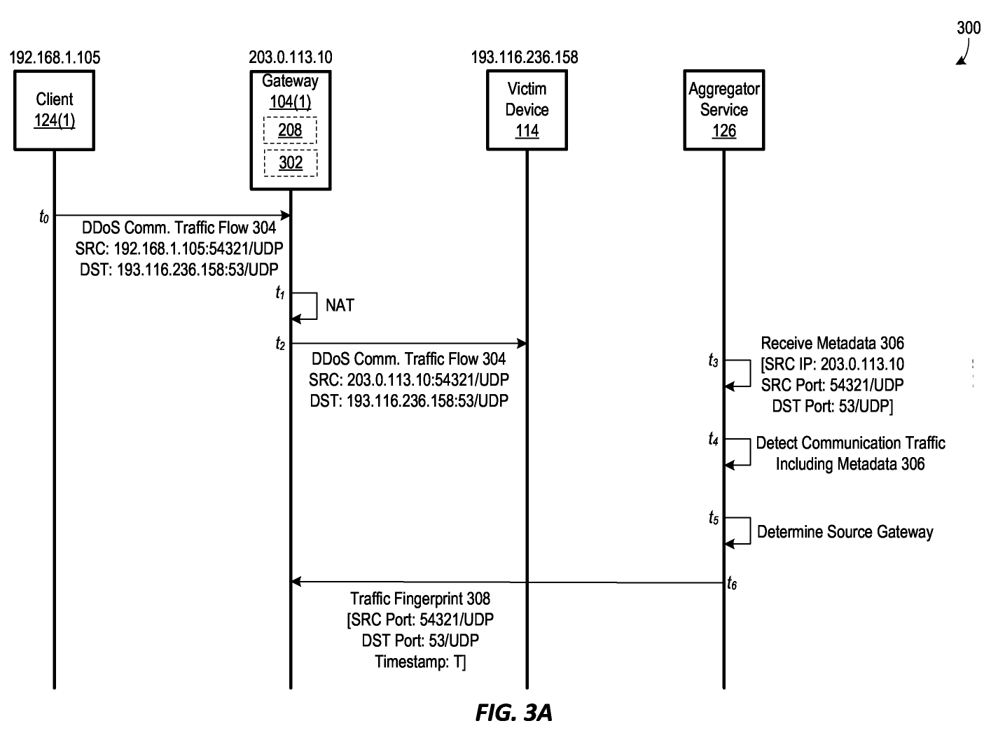

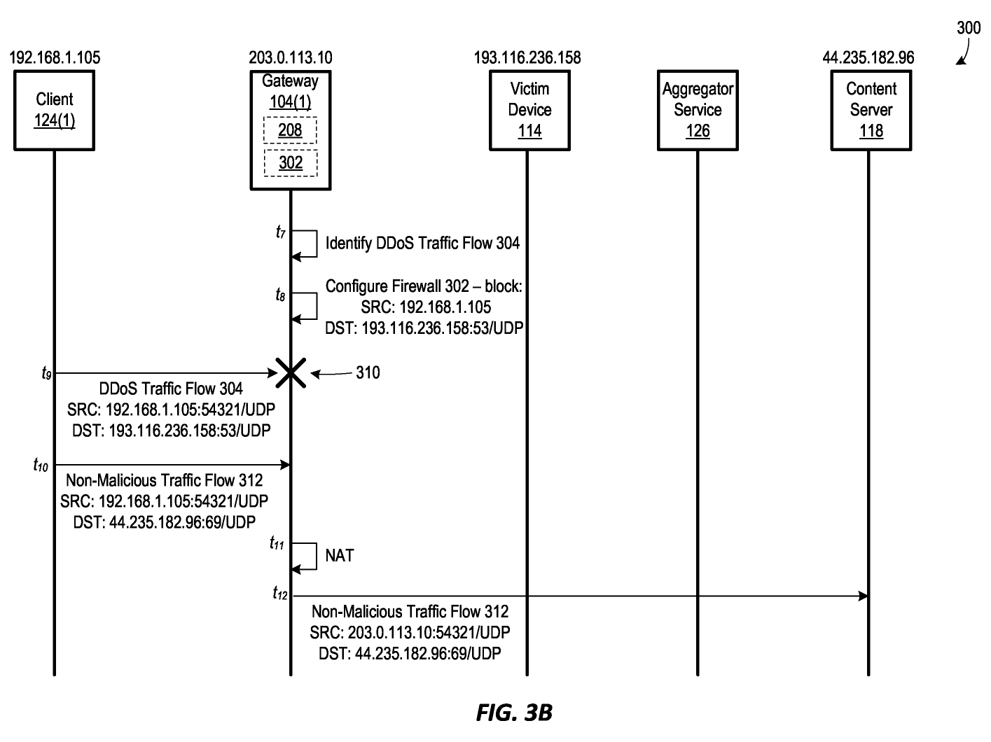

FIGS. 3A and 3B are collectively a dataflow diagram 300 illustrating one example of gateway 104(1) identifying a DDoS traffic flow by comparing a traffic fingerprint to a connection log. FIGS. 3A and 3B assume that (i) gateway 104(1) has previously subscribed to management service of management controller 108 as described above with respect to FIG. 2, (ii) gateway 104(1) has previously received filtering rules 208 from filtering manager 128, (iii) client 124(1) is infected with malware and is generating DDoS traffic directed at victim device 114, (iv) gateway 104(1) includes a firewall 302, (v) gateway 104(1) is configured to perform NAT, and (vi) IP addresses are as follows: (a) client 124(1) has a private IP address of 192.168.1.105, (b) gateway 104(1) has a public IP address of 203.0.133.10, (iii) victim device 114 has a public IP address of 193.116.236.158, and (iv) content server 118 has a public IP address of 44.235.182.96. FIGS. 3A and 3B include vertical lines logically representing each of client 124(1), gateway 104(1), victim device 114, and aggregator service 126, and FIG. 3B additionally includes a vertical line logically representing content server 118.

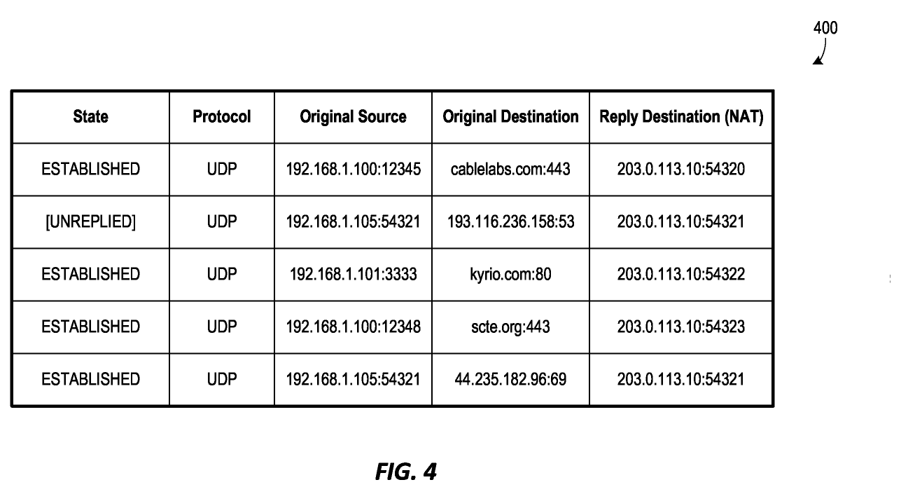

At a time t₀ (FIG. 3A), client 124(1) initiates a DDoS communication traffic flow 304 with a source (SRC) IP addresses 192.168.1.105, a source UDP port 54321, a destination (DST) IP address 193.116.236.158, and destination UDP port 53. At a time t 1, gateway 104(1) receives DDoS communication traffic flow 304 and performs NAT by changing a source address of DDoS communication traffic flow 304 from the private IP address of client 124(1), i.e., 192.168.1.105, to the public IP address of gateway 104(1), i.e., 203.0.113.110. Gateway 104(1) also records this NAT in a connection log in the form of a NAT table 400 of gateway 104(1). FIG. 4 illustrates NAT table 400 and shows that the NAT performed for DD0S traffic flow 304 is recorded in the second row of NAT table 400. Each row of NAT table 400 corresponds to respective traffic flow through gateway 104(1). Additionally, NAT table 400 includes the following columns: (i) traffic flow state, (ii) traffic flow protocol, e.g., UDP or TCP, (iii) original source IP address, (iv) original destination, and (v) reply destination after gateway 104(1) performs NAT. While NAT table 400 only includes five rows for illustrative simplicity, it is anticipated that NAT table 400 may include significantly more rows, depending on the level of activity of LAN 106(1). Furthermore, NAT table 400 could include additional and/or alternative fields. For example, in some alternate embodiments, NAT table 400 further includes a source identifier for each source, e.g., MAC address or other unique identifier for each source.

Referring again to FIG. 3A, at a time t₂, gateway 104(1) forwards DDoS communication traffic flow 304 to victim device 114 via communication service provider’s network 102 (not shown in FIGS. 3A and 3B) and the Internet 112 (not shown in FIGS. 3A and 3B). As such, victim device 114 is under a DDoS attack from client 124(1). At a time t₃, aggregator service 126 receives a message from detection service 110 (not shown in FIGS. 3A and 3B) reporting the DDoS attack on victim device 114 and providing metadata 306 of the DDoS attack. Metadata 306 includes, for example, source IP address 203.0.113.10 of the DDoS communication traffic, source port identity (54321) of the DDoS communication traffic, source port type (UDP) of the DDoS communication traffic, destination port identity (53) of the DDoS communication traffic, and destination port type (UDP) of the DDoS communication traffic. As another example, metadata 306 may include one or more pattens representing undesired communication traffic. At a time t₄, aggregator service 126 detects communication traffic in communication service provider’s network 102 matching metadata 306. For example, aggregator service 126 may detect communication traffic in communication service provider’s network 102 matching metadata 306 by matching one or more patterns included in metadata 306 with communication traffic in communication service provider’s network 102 with a confidence level that is at least a predetermined minimum value. In response to the detection at time t 4, aggregator service 126 determines at a time t₅ that gateway 104(1) is the source of communication traffic matching metadata 306 by matching IP address 203.0.113.10 of metadata 306 with IP address 203.0.113.10 of gateway 104(1) stored during the subscription example of FIG. 2.

At a time t₆, aggregator service 126 generates a traffic fingerprint 308 for gateway 104(1) including characteristics of the undesired communication traffic detected by aggregator service 126 at time t₄, and aggregator service 126 sends the traffic fingerprint 308 to gateway 104(1) at least partially using communication service provider’s network 102. In this example, traffic fingerprint 308 includes (i) source port identity (54321) of the undesired communication traffic, (ii) source port type (UDP) of the undesired communication traffic, (iii) destination port identity (53) of the undesired communication traffic, (vi) destination port type (UDP) of the undesired communication traffic, and (v) a timestamp T. Timestamp T represents a time that aggregator service 126, or detection service 110, detected the undesired communication traffic corresponding to the reported DDoS attack, and timestamp T is, for example, an absolute time, a relative time, or a time range. Aggregator service 126 optionally encrypts traffic fingerprint 308, e.g., using public key 204 of gateway 104(1), before sending traffic fingerprint 308 to gateway 104(1), and gateway 104(1) subsequently decrypts traffic fingerprint 308 using its private key. It should be noted that encrypting traffic fingerprint 308 with public key 204 prevents any device other than gateway 104(1) from viewing the traffic fingerprint, thereby promoting privacy and security.

Generating traffic fingerprint 308 including solely source port identity, source port type, destination port identity, destination port type, and a timestamp, as illustrated in FIG. 3A, advantageously minimizes sensitive information expressed by traffic fingerprint 308. For example, traffic fingerprint 308 does not include information on victim device 114, other than its destination port, thereby promoting privacy of victim device 114. However, it is understood that traffic fingerprint 308 could include additional and/or alternative information without departing from the scope hereof. For example, traffic fingerprint 308 could include an IP address of a victim device in addition to, or in place of, a destination port of a victim device. As another example, traffic fingerprint 308 could be a 4-tupple of (i) a source IP address, (ii) a source port, (iii) a destination IP address, and (iv) a destination port. As an additional example, traffic fingerprint 308 could omit a timestamp. As a further example, traffic fingerprint 308 could include one or more wildcards, such as to facilitate mitigating a DDoS attack again multiple victims with similar IP addresses. For instance, traffic fingerprint 308 could include victim device 114’s partial IP address in the form of 193.115.236.x, where x is a wildcard that could range from 0 to 255.

Referring to FIG. 3B, at a time t₇, gateway 104(1) matches traffic fingerprint 308 with a traffic flow listed in NAT table 400. Specifically, gateway 104(1) matches UDP source port 54321 and UDP destination port 53 with the traffic flow recorded in the second row of NAT table 400, i.e., DDoS communication traffic flow 304, and gateway 104(1) therefore determines that the traffic flow recorded in the second row of NAT table 400 is an undesired traffic flow. Gateway 104(1) may use timestamp T to help match the traffic fingerprint to a traffic flow recorded in the second row of NAT table 400, e.g., by limiting searching of NAT table 400 to a particular time range in the vicinity of timestamp T or by limiting searching of NAT table 400 to timestamp T in cases where timestamp T is a time range. Additionally, gateway 104(1) determines from the second row of NAT table 400 that the undesired traffic flow has the following attributes: (i) a source IP address of 192.168.1.105 and (ii) a destination IP address of 193.116.236.158. In response thereto, gateway 104(1) configures firewall 302 at a time t 8 in accordance with previously received filtering rules 208 to block a traffic flow with the following attributes: (i) source IP address 192.168.1.105, (ii) destination IP address 193.116.236.138, and (iii) destination UDP port 53. As such, gateway 104(1) and management controller 108 have collectively automatically blocked DDoS communication traffic flow 304. For example, at a time t 9, client 124(1) continues DDoS communication traffic flow 304, but firewall 302 blocks 310 DDoS communication traffic flow 304. It should be noted that gateway 104(1) and management controller 108 are able to collectively automatically block DDoS communication traffic flow 304 without management controller 108 having knowledge of LAN 106(1), as well as without gateway 104(1) having initial knowledge victim device 114’s IP address.

Additionally, the above-discussed automatic blocking of DDoS communication traffic flow 304 advantageously does not interfere with other traffic flows of client 124(1). For example, referring again to FIG. 3B, at a time t₁₀, client 124(1) initiates a non-malicious traffic flow 312 to content server 118 having the following attributes: (i) source IP address 192.168.1.105, (ii) UDP source port 54321, (iii) destination IP address 44.235.182.96, and (iv) destination UDP port 69. These attributes do not match the attributes of blocked DDoS communication traffic flow 304, and firewall 302 therefore allows non-malicious traffic flow 312 to flow through gateway 104(1) towards its destination. Specifically, at a time t₁₁, gateway 104(1) receives non-malicious traffic flow 312 and performs NAT by changing a source address of non-malicious traffic flow 312 from the private IP address of client 124(1), i.e., 192.168,1.105 to the public IP address of gateway 104(1), i.e., 203.0.113.110. Gateway 104(1) also records this NAT in NAT table 400, as shown in last row of NAT table 400.

Many variations in the example of FIGS. 3A and 3B are possible. For example, filtering rules 208 may specify that gateway 104(1) manages DDoS communication traffic flow 304 by performing an action other than blocking DDoS communication traffic flow 304. For example, filtering rules 208 may instead specify that gateway 104(1) black-hole DDoS communication traffic flow 304, delay DDoS communication traffic flow 304, tag DDoS communication traffic flow 304, redirect DDoS communication traffic flow 304, mirror DDoS communication traffic flow 304, store DDoS communication traffic flow 304, or make a copy of DDoS communication traffic flow 304. As another example, filtering rules 208 may specify that gateway 104(1) configure firewall 302 to block, or otherwise manage, a communication traffic flow having attributes with one or more wildcards. For example, filtering rules 208 may specify that gateway 104 block communication traffic having the following attributes: (i) source IP address 192.168.1.105, (ii) destination address 193.116.236.y, where y is a wildcard ranging from 0 to 255, and (iii) destination UDP port 53. Such use of wildcards may facilitate mitigating a “carpet bombing” DDoS attack that is directed at multiple secondary victim devices in addition to a primary victim device. As a further example, in embodiments where gateway 104(1) does not perform NAT, gateway 104(1) could be configured to match the traffic fingerprint to a connection log of gateway 104(1) other than a NAT table.

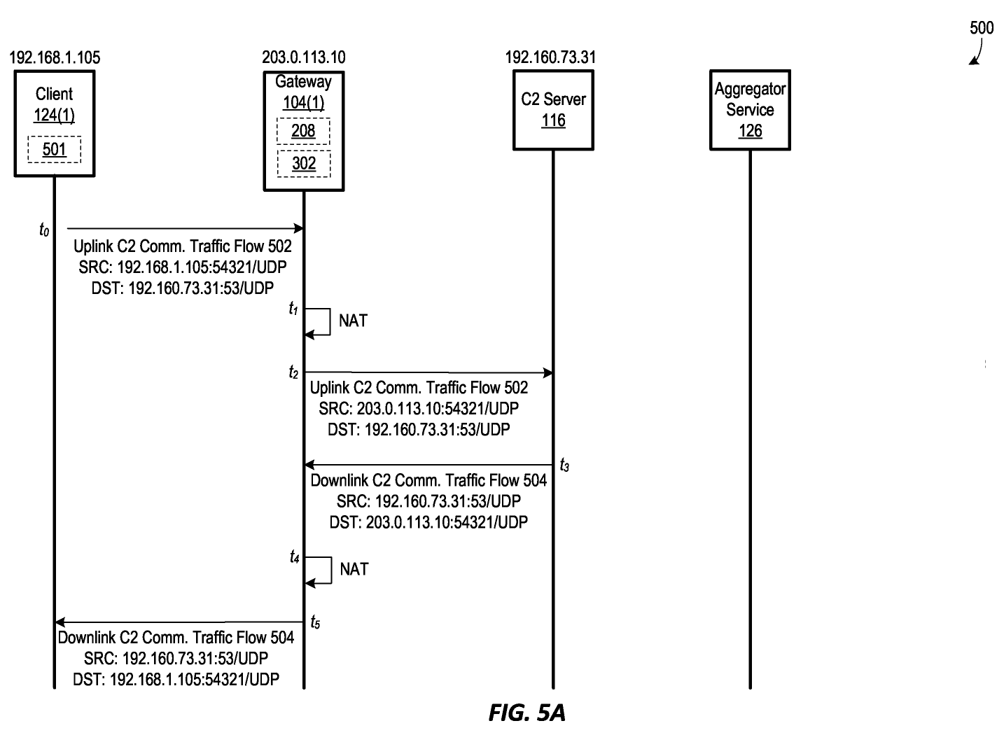

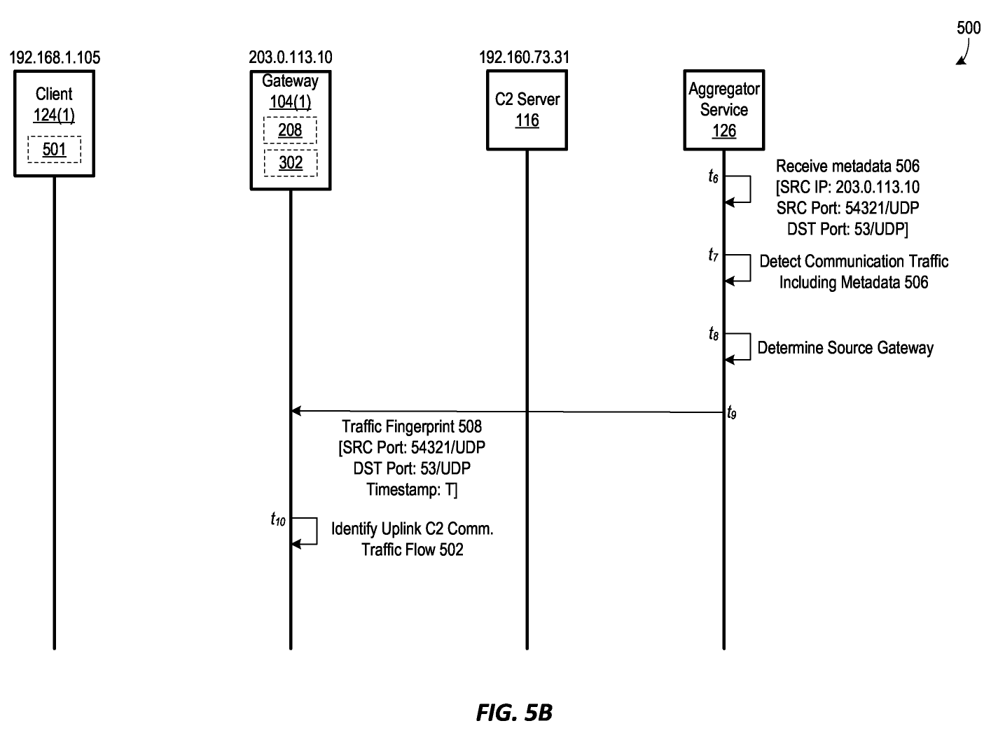

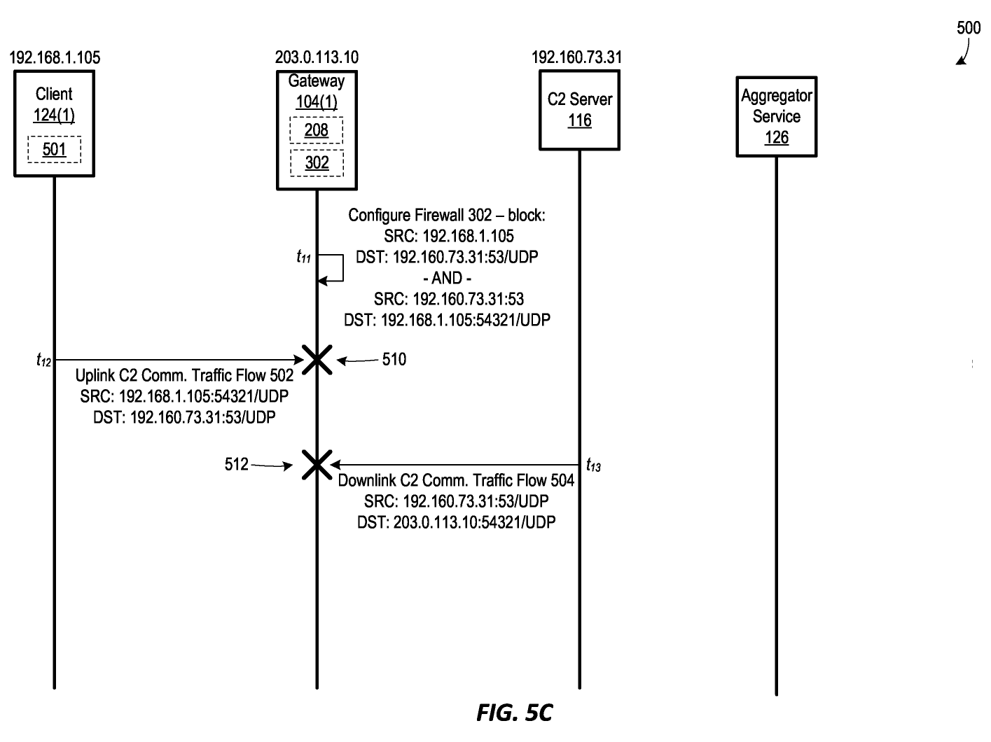

Additionally, the example of FIGS. 3A and 3B could be adapted to mitigate undesired communication traffic other than DDoS communication traffic. For example, FIGS. 5A, 5B, and 5C are collectively a dataflow diagram 500 illustrating one example of gateway 104(1) identifying a C2 traffic flow by comparing a traffic fingerprint to a connection log. FIGS. 5A, 5B, and 5C assume that (i) gateway 104(1) has previously subscribed to management service of management controller 108 as described above with respect to FIG. 2, (ii) gateway 104(1) has previously received filtering rules 208 from filtering manager 128, (iii) client 124(1) includes an infected host 501 that communicates with C2 server 116, (iv) gateway 104(1) includes firewall 302, (v) gateway 104(1) performs NAT, and (vi) IP addresses are as follows: (a) client 124(1) has a private IP address of 192.168.1.105, (b) gateway 104(1) has a public IP address of 203.0.133.10, and (iii) C2 server 116 has a public IP address of 192.160.73.31. FIGS. 5A, 5B, and 5C include vertical lines logically representing each of client 124(1), gateway 104(1), server 116, and aggregator service 126.

At a time t 0 (FIG. 5A), client 124(1) initiates an uplink C2 communication traffic flow 502 with a source IP addresses 192.168.1.105, a source UDP port 54321, a destination IP address 192.160.73.31, and destination UDP port 53. At a time t 1, gateway 104(1) receives uplink C2 communication traffic flow 502 and performs NAT by changing a source address of uplink C2 communication traffic flow 502 from the private IP address of client 124(1), i.e., 192.168.1.105, to the public IP address of gateway 104(1), i.e., 203.0.113.110. Gateway 104(1) also records this NAT in a NAT table analogous to NAT table 400 of FIG. 4. At a time t 2, gateway 104(1) forwards uplink C2 communication traffic flow 502 to C2 server 116 via communication service provider’s network 102 (not shown in FIGS. 5A, 5B, and 5C) and the Internet 112 (not shown in FIGS. 5A, 5B, and 5C). At a time t₃, C2 server 116 initiates a downlink C2 communication traffic flow 504 with a source IP addresses 192.160.73.31, a source UDP port 53, a destination IP address 203.0.113.110, and destination UDP port 54321. At a time t 4, gateway receives downlink C2 communication traffic flow 504 and performs NAT by changing a destination address of the downlink C2 communication traffic flow from the public IP address of gateway 104(1), i.e., 203.0.113.110, to the private IP address of client 124(1), i.e., 192.168.1.105. At a time t 5, gateway 104(1) forwards downlink C2 communication traffic flow 504 to client 124(1).

At a time t₆ (FIG. 5B), aggregator service 126 receives a message from detection service 110 (not shown in FIGS. 5A, FIG. 5B, and FIG. 5C) reporting detection of C2 communication traffic and providing metadata 506 of the C2 communication traffic. Metadata 506 includes, for example, source IP address 203.0.113.10 of uplink C2 communication traffic flow 502, source port identity (54321) of uplink C2 communication traffic flow 502, source port type (UDP) of uplink C2 communication traffic flow 502, destination port identity (53) of uplink C2 communication traffic flow 502, and destination port type (UDP) of uplink C2 communication traffic flow 502. At a time t 7, aggregator service 126 detects communication traffic in communication service provider’s network 102 matching metadata 506 In response thereto, aggregator service 126 determines at a time t 8 that gateway 104(1) is the source of communication traffic matching metadata 506 by matching IP address 203.0.113.10 of metadata 306 with IP address 203.0.113.10 of gateway 104(1) that was stored during the subscription example of FIG. 2.

At a time t₉, aggregator service 126 generates a traffic fingerprint 508 for gateway 104(1) including characteristics of the undesired communication traffic detected by aggregator service 126 at time t₇, and aggregator service 126 sends traffic fingerprint 508 to gateway 104(1) at least partially using communication service provider’s network 102. In this example, traffic fingerprint 508 includes (i) source port identity (54321) of the undesired communication traffic, (ii) source port type (UDP) of the undesired communication traffic, (iii) destination port identity (53) of the undesired communication traffic, (vi) destination port type (UDP) of the undesired communication traffic, and (v) a timestamp T. Timestamp T represents a time that aggregator service 126, or detection service 110, detected the undesired C2 communication traffic, and timestamp T is, for example, an absolute time, a relative time, or a time range. Aggregator service 126 optionally encrypts traffic fingerprint 508, e.g., using public key 204 of gateway 104(1), before sending traffic fingerprint 508 to gateway 104(1), and gateway subsequently decrypts traffic fingerprint 508 using its private key. It is understood that traffic fingerprint 508 could include additional and/or alternative information, including one or more wildcards, without departing from the scope hereof.

At a time t₁₀, gateway 104(1) matches the traffic fingerprint 508 with a traffic flow listed in a NAT table, i.e., uplink C2 communication traffic flow 502, in a manner analogous to that discussed above with respect to the example of FIGS. 3A and 3B, to determine that there is an undesired communication traffic flow between (i) IP address 192.168.1.105, UDP port 54321 and (ii) IP address 192.160.73.31, UDP port 53. In response thereto, gateway 104(1) configures firewall 302 at a time t₁₁ (FIG. 5C) in accordance with previously received filtering rules 208 to block a traffic flow with the following attributes: (i) source IP address 192.168.1.105, (ii) destination IP address 192.160.73.31, and (iii) destination UDP port 53. Additionally, gateway 104(1) configures firewall 302 in accordance with previously received filtering rules 208 to block a traffic flow with the following attributes: (i) source IP address 192.160.73.31, (ii) destination IP address 192.168.1.105, and (iii) destination UDP port 54321. As such gateway 104(1) and management controller 108 have collectively automatically blocked both uplink C2 communication traffic and downlink C2 communication traffic associated with client 124(1). For example, at a time t₁₂, client 124(1) continues uplink C2 communication traffic flow 502 to C2 server 116, but firewall 302 blocks 510 uplink C2 communication traffic flow 502. As another example, at a time t₁₃, C2 server 116 continues downlink C2 communication traffic flow 504 to client 124(1), but firewall 302 blocks 512 downlink C2 communication traffic flow 504. However, gateway 104(1) does not interfere with other traffic flows of client 124(1).

Many variations in the example of FIGS. 5A, 5B, and 5C are possible. For example, filtering rules 208 may specify that gateway 104(1) blocks either uplink C2 communication traffic or downlink C2 communication traffic, instead of both of uplink C2 communication traffic and downlink C2 communication traffic. As another example, filtering rules 208 may specify that gateway 104(1) manages a C2 communication traffic flow by performing an action other than blocking the C2 communication traffic flow. For example, filtering rules 208 may instead specify that gateway 104(1) black-hole the C2 communication traffic flow, delay the C2 communication traffic flow, tag the C2 communication traffic flow, redirect the C2 communication traffic flow, mirror the C2 communication traffic flow, store the C2 communication traffic flow, or copy the C2 communication traffic flow. As another example, in embodiments where gateway 104(1) does not perform NAT, gateway 104(1) could be configured to match the traffic fingerprint to a connection log other than a NAT table.

### Example C – Packet Matching Using a Traffic Fingerprint

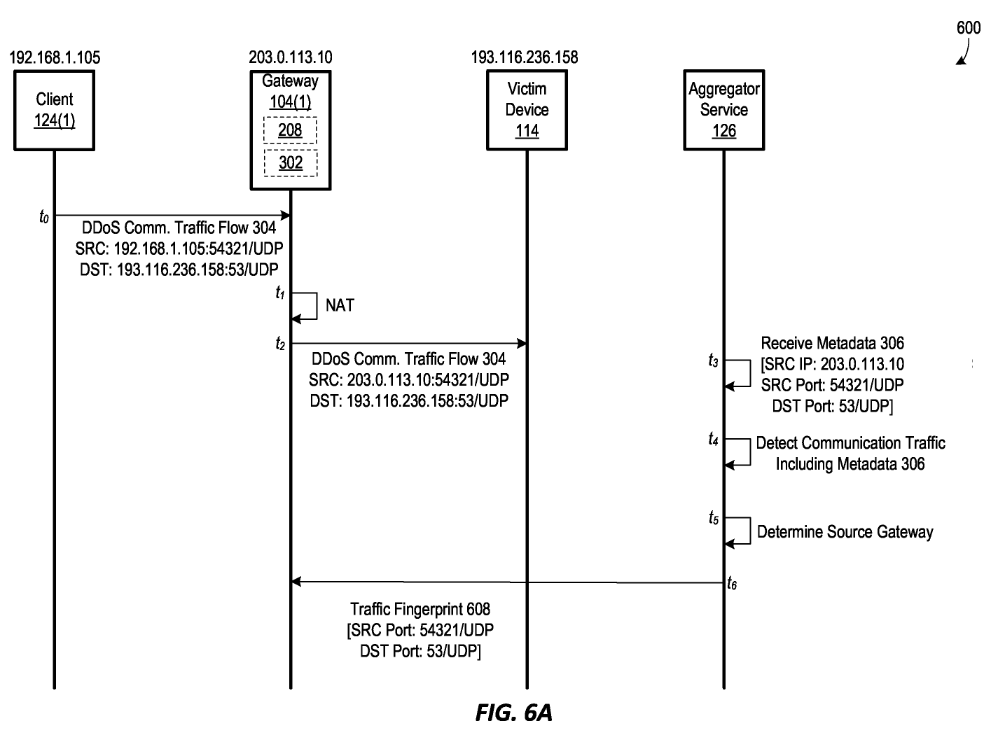

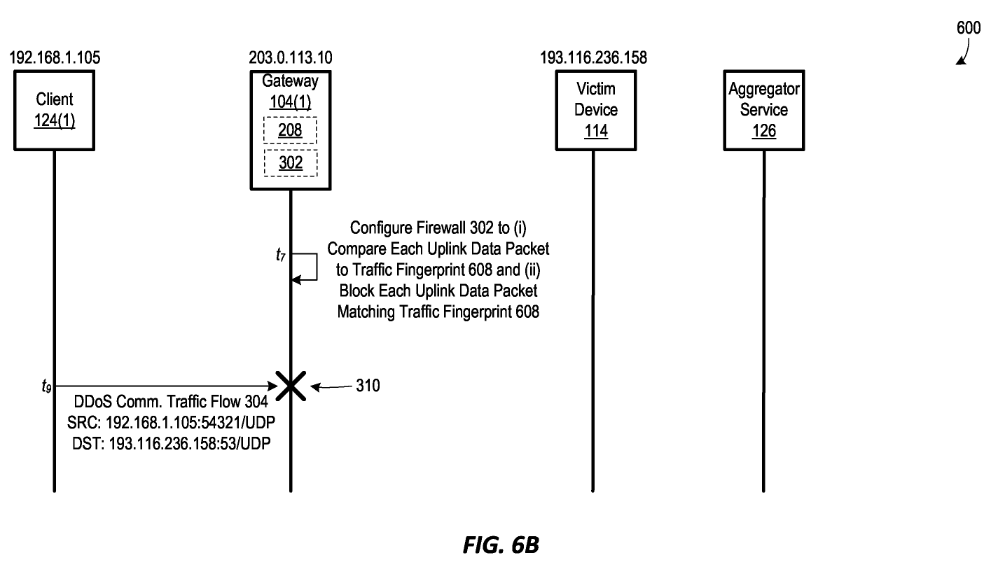

FIGS. 6A and 6B are collectively a dataflow diagram 600 illustrating one example of gateway 104(1) identifying a DDoS communication traffic flow by comparing a traffic fingerprint to each data packet, or to another type of data structure, flowing through gateway 104(1). Comparing a traffic fingerprint to each data packet, or each other type of data structure, may be useful, for example, in embodiments where gateway 104(1) does not maintain a connection log, such as in embodiments where gateway 104(1) does not perform NAT. FIGS. 6A and 6B assume that (i) gateway 104(1) has previously subscribed to management service of management controller 108 as described above with respect to FIG. 2., (ii) gateway 104(1) has previously received filtering rules 208 from filtering manager 128, (iii) client 124(1) is infected with malware and is generating DDoS communication traffic directed at victim device 114, (iv) gateway 104(1) includes firewall 302, and (v) IP addresses are as follows: (a) client 124(1) has a private IP address of 192.168.1.105, (b) gateway 104(1) has a public IP address of 203.0.133.10, and (iii) victim device 114 has a public IP address of 193.116.236.158. FIGS. 6A and 6B include vertical lines logically representing each of client 124(1), gateway 104(1), victim device 114, and aggregator service 126.

Dataflow diagram 600 of FIGS. 6A and 6B is substantively the same as dataflow diagram 300 of FIGS. 3A and 3B up through time t₅. Therefore, actions occurring at times t₀ through t₅ of dataflow diagram 600 are not discussed in the interest of brevity. However, dataflow diagram 600 departs from dataflow diagram 300 beginning at time t 6. Specifically, at time t₆, aggregator service 126 generates a traffic fingerprint 608 including (i) source port identity (54321) of the undesired communication traffic, (ii) source port type (UDP) of the undesired communication traffic, (iii) destination port identity (53) of the undesired communication traffic, and (vi) destination port type (UDP) of the undesired communication traffic. Traffic fingerprint 608 does not include a timestamp because gateway 104(1) does not search a connection log to identify undesired communication traffic. Instead, at a time t₇ (FIG. 6B), gateway 104(1) configures firewall 302 in accordance with filtering rules 208 to (i) compare traffic fingerprint 608 to each uplink data packet flowing through gateway 104(1) and (ii) block each uplink data packet flowing through gateway 104(1) that matches traffic fingerprint 308. As such, firewall 302 blocks data packets of DDoS communication traffic flow 304 without interfering with other uplink data packets that do not match traffic fingerprint 308. For example, at a time t₉, client 124(1) continues DDoS communication traffic flow 304, but firewall 302 blocks 310 DDoS communication traffic flow 304 by blocking data packets matching traffic fingerprint 608.

Gateway 104(1) may indefinitely continue to compare each uplink data packet passing therethrough to traffic fingerprint 608. Alternately, gateway 104(1) may discontinue the aforementioned comparison after a predetermined time period has elapsed or another action has occurred, such as eradication of DDoS malware from client 124(1). In a manner similar to that discussed above with respect to dataflow diagram 300, filtering rules 208 may specify that gateway 104(1) manage data packets matching traffic fingerprint 608 by performing an action other than blocking the data packets. For example, filtering rules 208 may instead specify that gateway 104(1) black-hole data packets matching traffic fingerprint 608, delay data packets matching traffic fingerprint 608, tag data packets matching traffic fingerprint 608, redirect data packets matching traffic fingerprint 608, mirror data packets matching traffic fingerprint 608, store data packets matching traffic fingerprint 608, or copy data packets matching traffic fingerprint 608.

### Example D –Matching Using a Machine Learning Model

Referring again to FIG. 1, in some alternate embodiments, one or more gateways 104 are configured to detect undesired communication traffic using a machine learning model in place of, or in addition to, using a traffic fingerprint to detect undesired communication traffic. For example, a gateway 104 may include a machine learning model that analyzes communication traffic passing through the gateway 104 and classifies the communication traffic as either undesired communication traffic or desired communication traffic. A firewall of the gateway 104 may then (i) allow desired communication to proceed through the gateway 104 and (ii) manage undesired communication traffic, such as by (a) impeding the undesired communication traffic, e.g., by blocking the undesired communication traffic, black-holing the undesired communication traffic, or delaying the undesired communication traffic, (b) tagging the undesired communication traffic, such as by adding in-band telemetry data to the communication traffic, (c) redirecting the undesired communication traffic, (d) mirroring the undesired communication traffic, (e) storing the undesired communication traffic, or (f) copying the undesired communication traffic. A gateway 104 including a machine learning model may be configured to provide automatic and/or manual feedback on classification performed by the machine learning model to train the model. For example, a gateway 104 may be configured to enable a user to accept or reject a machine model’s classification of communication traffic. As another example, filtering manager 128 may provide feedback to a machine learning model of a gateway 104 on classification performed by the machine learning model. Additionally, in some embodiments, a gateway 104 including a machine learning model may be configured to classify communication traffic flowing through the gateway 104 as either desired or undesired at least partially based on in-band telemetry data included in the communication traffic flowing through the gateway.

In some embodiments, filtering manager 128 provides machine learning models to gateways 104, such as (i) after a gateway 104 subscribes to management service of management controller 108, (ii) according to a predetermined schedule, and/or (iii) in response to new detection of undesired communication traffic, e.g., as reported by detection service 110. Filtering manager 128 may subsequently update machine learning models of gateways 104, such as in response to new detection of undesired communication traffic. Filtering manager 128 may update machine learning models, for example, by sending updated weights for the machine learning models to gateways 104.

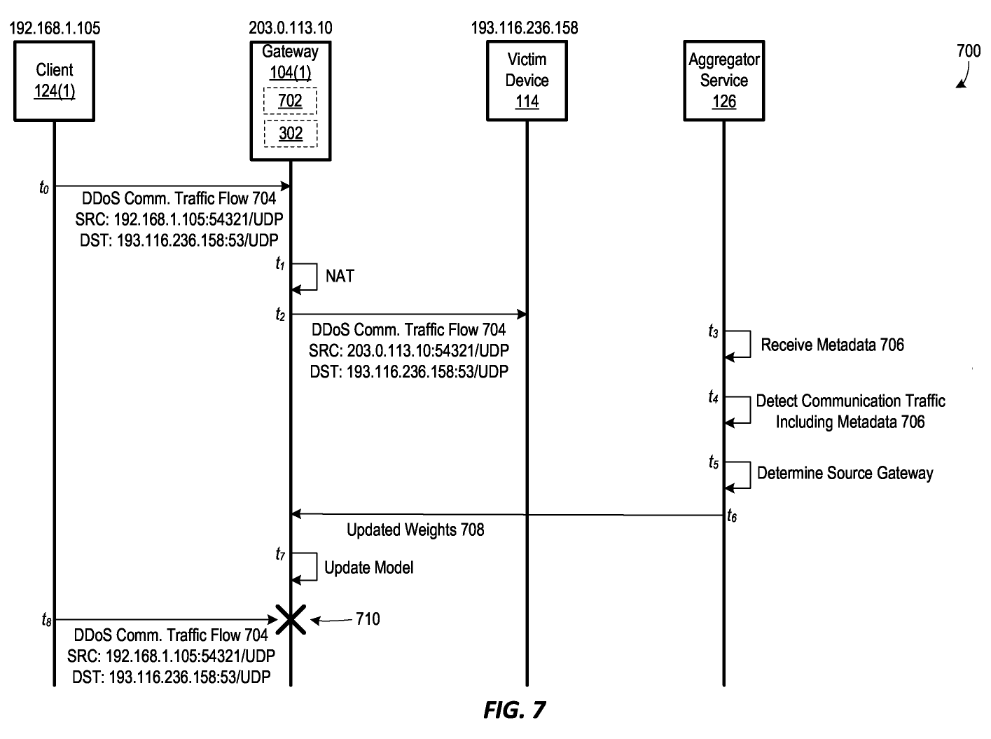

FIG. 7 is a dataflow diagram 700 illustrating one example of gateway 104(1) identifying a DDoS traffic flow using a machine learning model. FIG. 7 assumes that (i) gateway 104(1) has previously subscribed to management service of management controller 108, (ii) gateway 104(1) has previously received a machine learning model 702 from filtering manager 128, (iii) client 124(1) is infected with malware and is generating DDoS communication traffic directed at victim device 114, (iv) gateway 104(1) includes firewall 302, (v) gateway 104(1) is configured to perform NAT, and (vi) IP addresses are as follows: (a) client 124(1) has a private IP address of 192.168.1.105, (b) gateway 104(1) has a public IP address of 203.0.113.10, and (iii) victim device 114 has a public IP address of 193.116.236.158. FIG. 7 includes vertical lines logically representing each of client 124(1), gateway 104(1), victim device 114, and aggregator service 126.

Machine learning model 702 is configured to classify communication traffic flowing through gateway 104(1) as either desired or undesired, such as on a data packet basis or on a traffic flow basis. For example, machine learning model 702 may classify each of DDoS communication traffic and C2 communication traffic as undesired, while classifying non-malicious communication traffic as desired. However, machine learning model 702 has not yet been trained to recognize DDoS communication traffic originating from client 124(1) at a time t₀. In particular, at time t₀, client 124(1) initiates a DDoS communication traffic flow 704 with a source IP addresses 192.168.1.105, a source UDP port 54321, a destination IP address 193.116.236.158, and destination UDP port 53. At a time t₁, gateway 104(1) receives DDoS communication traffic flow 704, and machine learning model 702 classifies the traffic flow as desired because machine learning model has not yet been trained to recognize DDoS communication traffic flow 704 as being undesired. Therefore, gateway 104(1) allows DDoS communication traffic flow 704 to proceed by (i) performing NAT, i.e., by changing a source address of DDoS communication traffic flow 704 from 192.168.1.105 to 203.0.113.110, and (ii) forwarding DDoS communication traffic flow 704 to victim device 114 at a time t₂. As such, victim device 114 is under a DDoS attack from client 124(1).

At a time t₃, aggregator service 126 receives a message from detection service 110 (not shown in FIG. 7) reporting the DDoS attack on victim device 114 and providing metadata 706 of the DDoS attack. Metadata 706 includes, for example, one or more of (i) communication traffic flow parameters, such as source IP address, destination IP address, source port, and/or destination port, (ii) communication payload data of the DDoS communication traffic, such as patterns and/or byte sequences within data packet payloads, and (iii) DDoS communication traffic flow characteristics, such as timing and/or spacing between data packets in a traffic flow. At a time t₄, aggregator service 126 detects communication traffic in communication service provider’s network 102 matching metadata 706. In response thereto, aggregator service 126 determines at a time t₅ that gateway 104(1) is the source of communication traffic matching metadata 706, e.g., by matching IP address 203.0.113.10 of metadata 706 with IP address 203.0.113.10 of gateway 104(1) stored during the subscription of gateway 104(1) to management service of management controller 108.

At a time t₆, filtering manager 128 generates updated weights 708 for machine learning model 702 at least partially based on metadata 706, and filtering manager 128 sends updated weights to gateway 104(1) at least partially using communication service provider’s network 102. In some embodiments, filtering manager 128 encrypts updated weights 708 using gateway 104’s public key 204 before sending updated weights 708 to gateway 104(1), and gateway 104(1) subsequently decrypts updated weights 708 using its private key after receiving updated weights 708. Updated weights 708 enable machine learning model 702 to detect undesired communication traffic analogous to DDoS communication traffic flow 704. Gateway 104(1) updates machine learning model 702 with updated weights 708 at a time t₇, thereby training machine learning model 702 to recognize undesired communication traffic analogous to DDoS communication traffic flow 704. Accordingly, at a time t 8, client 124(1) continues DDoS communication traffic flow 704, but machine learning model 702 now classifies DDoS communication traffic flow 704 as undesired communication traffic, and in response to this classification, firewall 302 blocks 710 DDoS communication traffic flow 704.

In some embodiments, machine learning model 702 may implement behavioral analysis techniques described in the incorporated U.S. Patent Application Publication No. 2025/0317418 (the ’418 Publication). The ’418 Publication discloses, in part, methods for determining device complexity scores based on noise-to-signal ratios, establishing behavioral patterns for devices, and generating device communication models that define decision boundaries around normal traffic. The updated weights 708 may include parameters for an isolation forest anomaly detection algorithm (e,g., as described in FIGS. 14-16 of the ’418 Publication) that calculates flow confidence scores based on device complexity and behavioral boundaries. When DDoS communication traffic flow 704 is received at time t₈, gateway 104(1) applies the updated model to determine whether the traffic falls within the established behavioral boundary for client 124(1), and firewall 302 blocks traffic that deviates significantly from normal behavior. This behavioral model approach complements the traffic fingerprint approach shown in other figures, enabling detection of zero-day attacks and novel malware variants that do not match known fingerprints but exhibit anomalous behavior patterns.

### Example E – Additional Filtering Points

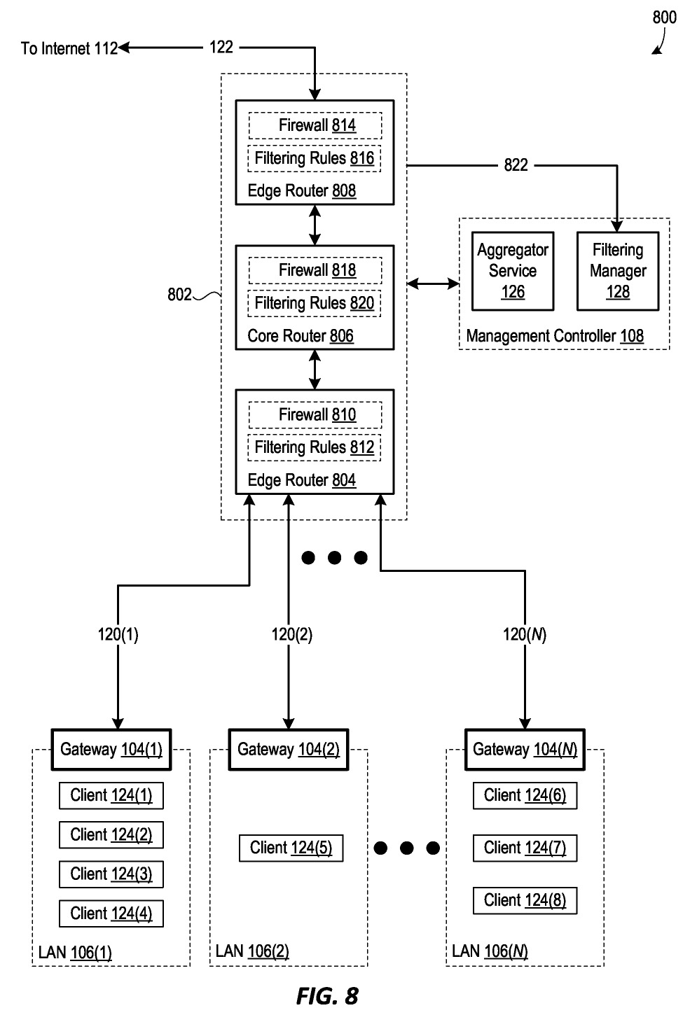

As discussed above, certain embodiments include multiple filtering points to enable undesired communication traffic to be managed at multiple points. For example, FIG. 8 is a schematic diagram of a communication environment 800, which is an alternate embodiment of communication environment 100 (FIG. 1) including additional filtering points. Communication environment 800 differs from communication environment 100 in that communication service provider’s network 102 is replaced with a communication service provider’s network 802. Detection service 110, the Internet 112, victim device 114, C2 server 116, and content server 118 are not shown in FIG. 8 due to illustrative space constraints, but it is understood that one or more of the elements may be present in communication environment 800.

Communication environment 800 includes network elements upstream of gateways 104 that are capable of functioning as filtering points. In particular, communication service provider’s network 802 includes an edge router 804, a core router 806, and an edge router 808 that are each upstream of gateways 104. Edge router 804 is configured to communicatively couple gateways 104 with communication service provider’s network 802, edge router 808 is configured to communicatively couple communication service provider’s network 802 with the Internet 112, and core router 806 is configured to communicatively couple edge router 804 with edge router 808. It is understood that communication service provider’s network 802 will typically include additional elements which are not shown for illustrative simplicity, and the architecture of communication service provider’s network 802 may vary without departing from the scope hereof. For example, communication service provider’s network 802 may include additional routers or fewer routers. As another example, one or more of edge router 804, edge router 808, and core router 806 could be replaced with another type of network element.

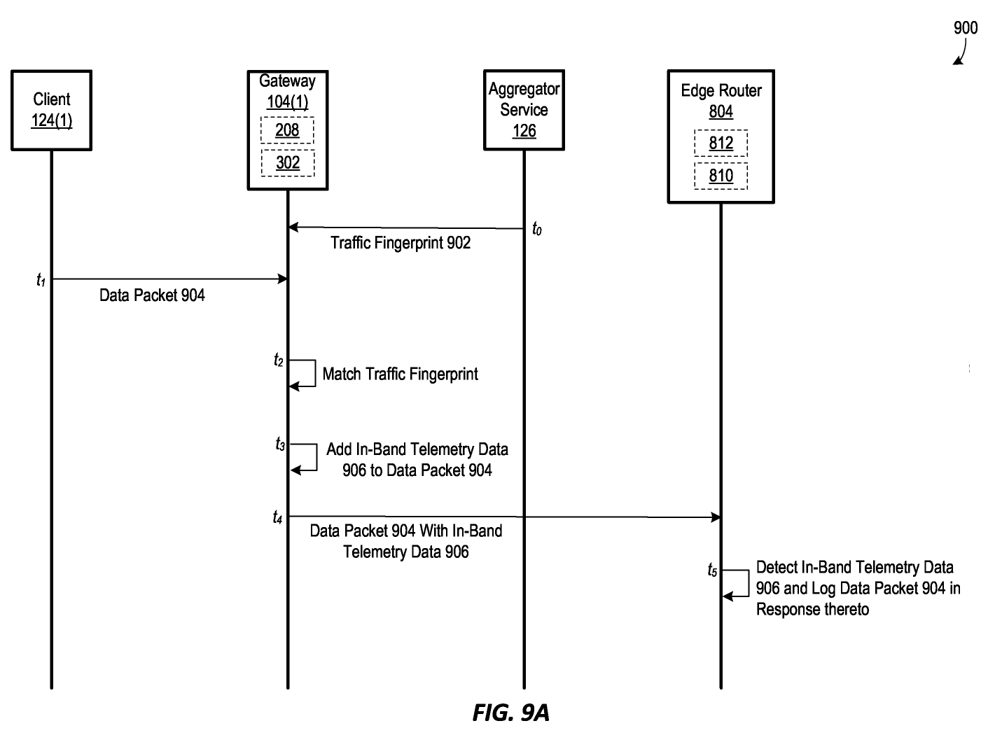

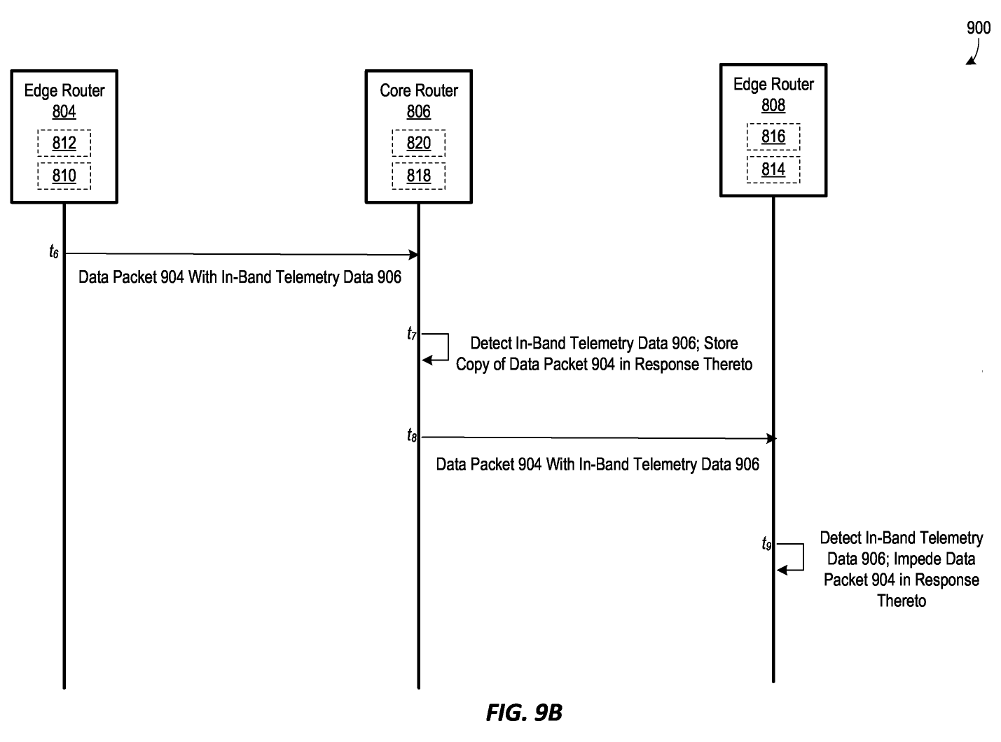

Each of edge router 804, core router 806, and edge router 808 is configured to operate as a filtering point under the control of management controller 108. In particular, edge router 804 includes a firewall 810 that is configured to filter communication traffic flowing therethrough in accordance with filtering rules 812 from filtering manager 128, and edge router 808 includes a firewall 814 that is configured to filter communication traffic flowing therethrough in accordance with filtering rules 816 from filtering manager 128. Similarly, core router 806 includes a firewall 818 that is configured to filter communication traffic flowing therethrough according to filtering rules 820 from filtering manager 128. One or more of edge router 804, edge router 808, and core router 806 may be configured to receive traffic fingerprints from aggregator service 126, machine learning models from filtering manager 128, and/or updated machine learning model weights from aggregator service 126, in a manner analogous to that discussed above with respect to gateways 104. In certain embodiments, one or more of edge router 804, edge router 808, and core router 806 is a P4-enabled device. In some embodiments, one or more of edge router 804, edge router 808, and core router 806 support in-band telemetry data, such as discussed below with respect to FIGS. 9A and 9B.

Each of edge router 804, edge router 808, and core router 806 may be configured to manage undesired communication traffic flowing therethrough using one or more techniques similar to those discussed above with respect to gateways 104. For example, one or more of edge router 804, edge router 808, and core router 806 may be configured to (i) detect undesired communication traffic by matching a traffic fingerprint received from aggregator service 126 to a connection log and (ii) manage the undesired communication traffic according to respective filtering rules 812, 816, and 820. As another example, one or more edge router 804, edge router 808, and core router 806 may be configured to (i) detect undesired communication traffic by matching a traffic fingerprint received from aggregator service 126 to each data packet flowing therethrough, (ii) and manage the undesired communication traffic according to respective filtering rules 812, 816, and 820. As a further example, one or more edge router 804, edge router 808, and core router 806 may be configured to (i) detect undesired communication traffic by classifying communication traffic flowing therefore using a machine learning model and (ii) and manage the undesired communication traffic according to respective filtering rules 812, 816, and 820.

Edge router 804, edge router 808, and core router 806 may manage undesired communication traffic according to their respective filtering rules 812, 816, and 820, for example, by (i) impeding the undesired communication traffic, such as by blocking the undesired communication traffic, black-holing the undesired communication traffic, or delaying the undesired communication traffic, (ii) tagging the undesired communication traffic, such as by adding in-band telemetry data to the undesired communication traffic, (iii) redirecting the undesired communication traffic, (iv) mirroring the undesired communication traffic, (v) storing the undesired communication traffic, and/o (vi) copy the undesired communication traffic. In some embodiments, one or more of filtering rules 812, 816, and 820 are supplemented by a match-action policy.

Management controller 108 could be configured to select which one or more filtering points to use to manage undesired communication traffic in various ways. For example, management controller 108 and/or detection service 110 (not shown in FIG. 8) could prioritize two or more types of undesired communication traffic, and management controller 108 could select filtering points for managing undesired communication traffic as follows: (i) manage undesired communication traffic having a priority of at least a predetermined threshold value using one or more of edge router 804, edge router 808, and core router 806, and (ii) manage undesired communication traffic having a priority that is below the predetermined threshold value using one or more gateways 104. As another example, management controller 108 could employ one or more gateways 104 for first level management of undesired communication traffic and use one or more of edge router 804, edge router 808, and core router 806 for any additional needed management of undesired communication traffic. As a further example, management controller 108 could use machine learning to determine an optimum selection of filtering points in communication environment 800 to manage undesired communication traffic. An optimum selection of filtering points could be, for example, a selection of filtering points that is most-effective at managing undesired communication traffic or a selection of filtering points that minimizes performance degradation from managing undesired communication traffic. In some embodiments, one or more of edge router 804, edge router 808, and core router 806 provide feedback information 822 to management controller 108 for logging undesired communication traffic detection and/or for use by filtering manager 128 when generating new filtering rules. Examples of possible information included in feedback information 822, include, but are not limited to, one or more of (i) a traffic fingerprint including a probability score based on an output of a machine learning algorithm where the probability score indicates, for example, probability of the traffic fingerprint corresponding to undesired communication traffic, (ii) NAT metadata, such as NAT device type, NAT device manufacturer, NAT device vendor, etc., (iii) malware detection information, and (iv) identification of one or more security vulnerabilities, such as identification of one or more open ports.

It should be noted that while FIG. 8 illustrates additional filtering points upstream of gateways 104, clients downstream of gateways 104 could also be configured to serve as filtering points. For example, in certain embodiments, one or more clients 124 are configured to manage undesired communication traffic at least partially based on filtering rules received from filtering manager 128, optionally in conjunction with one or more match-action policies.

### Example F – In-Band Telemetry Data

Referring again to FIG. 1, certain embodiments of gateways 104 are configured to add in-band telemetry data to undesired communication traffic, such as to enable a router, or another network element, upstream of gateways 104 to identify the undesired communication traffic and optionally manage the undesired communication traffic. For example, some embodiments of gateways 104 add in-band telemetry data to each data packet, such as to a respective header of each data packet, of undesired communication traffic to facilitate identification of the data packets upstream of the gateways. In some embodiments supporting P4, gateways 104 add a hashed flag, or another identifier, to a P4 INT header as in-band telemetry data. A gateway 104 adding a hashed flag or other identifier to a P4 INT header optionally digitally signs the hashed flag or other identifier to enable a receiving upstream network element, such as a router, to verify authenticity of the hashed flag or other identifier. In certain embodiments, the flag or other identifier includes a public key of a gateway 104, a MAC address of the gateway, and a destination IP address of the undesired communication traffic. The upstream network element may then manage the data packets according to filtering rules received from filtering manager 128, or from filtering rules received from a downstream filtering point, such as by impeding the data packets, adding further in-band telemetry data to the data packets, redirecting the data packets, mirroring the data packets, storing the data packets, logging the data packets, or copying the data packets.

FIGS. 9A and 9B are collectively a dataflow diagram 900 illustrating one example of filtering points using in-band telemetry data, in an embodiment of communication environment 800 (FIG. 8) where the filtering points support in-band telemetry data. FIG. 9A includes vertical lines logically representing each of client 124(1), gateway 104(1), aggregator service 126, and edge router 804. FIG. 9B includes vertical lines logically representing each of edge router 804, core router 806, and edge router 808. FIGS. 9A and 9B assume that each of gateway 104(1), edge router 804, core router 806, and edge router 808 is a respective P4-enable device supporting in-band telemetry data, and in some embodiments, each of edge router 804, core router 806, and edge router 808 supports in-band telemetry data at a line rate.

At a time t₀, gateway 104 receives a traffic fingerprint 902 from aggregator service 126. At a time t₁, client 124(1) initiates a data packet 904 that is part of an undesired communication traffic flow. The undesired communication traffic flow is, for example, a DDoS communication traffic flow or a C2 communication traffic flow. Gateway 104(1) matches traffic fingerprint 902 to data packet 904 at a time t₂, such as using one of the techniques discussed above. Dataflow diagram 900 assumes that filtering rules 208 specify that gateway 104(1) manage undesired communication traffic by tagging it. According, at a time t₃, gateway 104 adds in-band telemetry data 906 to data packet 904 to indicate that data packet 904 is part of undesired communication traffic, and at a time t₄, gateway 104(1) forwards data packet 904 to edge router 804. In certain embodiments, in-band telemetry data 906 includes a hashed flag or identifier to indicate to an upstream network element that undesired data packet 904 is part of an undesired communication traffic flow. Additionally, in particular embodiments, in-band telemetry data 906 excludes sensitive subscriber information, such as subscriber identification information or information of client 124(1), e.g., a MAC address of client 124(1), to promote privacy.

Dataflow diagram 900 assumes that filtering rules 812 specify that edge router 804 manage data packets including in-band telemetry data 906 by logging them, either locally at edge router 804 or externally, such as at management controller 108. Accordingly, at a time t₅, edge router 804 detects in-band telemetry data 906 in data packet 904, and in response thereto, edge router 804 logs detection of a data packet 904 with in-band telemetry data 906. Edge router 804 forwards data packet 904 to core router 806 at a time t 6 (FIG. 9B), and core router 806 detects in-band telemetry data 906 at a time t₇. Dataflow diagram 900 assumes that filtering rules 820 specify that core router 806 manage data packets including in-band telemetry data 906 by storing a copy of them. Accordingly, core router 806 stores a copy of data packet 904, such as for future analysis, at time t₇. Core router 806 forwards data packet 904 to edge router 808 at a time t₈, and edge router 808 detects in-band band telemetry data 906 in data packet 904 at a time t₉. Dataflow diagram 900 assumes that filtering rules 816 specify that edge router 808 manage data packets including in-band telemetry data 906 by impeding them, and edge router 808 accordingly impedes data packet 904 at time t₉, e.g., by blocking data packet 904, black-holing data packet 904, or delaying data packet 904.

Many variations to the example of dataflow diagram 900 are possible. For example, filtering rules could differ so that one or more network elements manage data packet 904 in a different manner. As another example, filtering rules could differ so that data packet 904 is blocked or black-holed before it is able to reach core router 806 or edge router 808.

### Example G – Mitigation of False Detection

It is possible that desired communication traffic may be erroneously classified as undesired communication traffic in the new systems and methods. For example, a bad actor may spoof a source IP address or a source MAC address of undesired communication traffic, leading to undesired communication traffic being attributed to the wrong source. As another example, a machine learning model of a filtering point may misclassify communication traffic as undesired. Accordingly, certain embodiments of the new systems and methods support a dispute resolution process whereby an end user who believes that their communication traffic has been falsely identified as undesired may initiate an appeal with filtering manager 128. For example, in some embodiments a filtering rule, a traffic fingerprint, and/or a sample of the communication traffic classified as undesired may be submitted to filtering manager 128. Filtering manager 128 may then assess the aforementioned submission, and filtering manager 128 may subsequently update a filtering rule and/or traffic fingerprint, if appropriate, to prevent further misclassification of the communication traffic as undesired. This process could be manually performed by the end user or by an agent of the end user. Alternately, this process could be at least partially automated. For example, a gateway 104 could be configured to automatically submit one or more of a filtering rule, a traffic fingerprint, and/or a sample of communication traffic to filtering manager 128 in response to a user input indicating erroneous classification of communication traffic.

### Combinations of Features

Features described above may be combined in various ways without departing from the scope hereof. The following examples illustrate some possible combinations.

(A1) A method operable by a gateway for managing undesired communication traffic, where the gateway communicatively couples a LAN with a communication service provider's network, includes the following steps: (1) receiving a traffic fingerprint from a management controller, the traffic fingerprint representing one or more characteristics of the undesired communication traffic, (2) comparing the traffic fingerprint to a connection log of the gateway to determine that the undesired communication traffic corresponds to a first communication traffic flow, the first communication traffic flow being a communication traffic flow of a first client of the LAN that flows through the gateway, and (3) in response to determining that the undesired communication traffic corresponds to the first communication traffic flow, managing the first communication traffic flow according to one or more filtering rules without interfering with a second communication traffic flow, the second communication traffic flow being another communication traffic flow of the first client of the LAN that flows through the gateway.

(A2) In the method denoted as (A1), the traffic fingerprint may include (i) an identity of a source port of the undesired communication traffic, (ii) a type of the source port of the undesired communication traffic, (iii) an identity of a destination port of the undesired communication traffic, and (iv) a type of the destination port of the undesired communication traffic.

(A3) In the method denoted as (A2), the traffic fingerprint may further include a timestamp representing a time when the undesired communication traffic was detected.

(A4) In any one of the methods denoted as (A1) through (A3), the traffic fingerprint may include one or more of (i) payload data characteristics of the undesired communication traffic and (ii) flow characteristics of the undesired communication traffic.

(A5) In any one of the methods denoted as (A1) through (A4), the traffic fingerprint may exclude an Internet Protocol (IP) address of a device receiving the undesired communication traffic, to preserve privacy of the device receiving the undesired communication traffic.

(A6) In any one of the methods denoted as (A1) through (A5), the connection log may be a network address translation (NAT) table of the gateway.

(A7) In any one of the methods denoted as (A1) through (A6), managing the first communication traffic flow according to one or more filtering rules may include impeding the first communication traffic flow.

(A8) In the method denoted as (A7), the gateway may impede the first communication traffic flow by one of (i) blocking the first communication traffic flow, (ii) black-holing the first communication traffic flow, and (iii) delaying the first communication traffic flow.

(A9) In any one of the methods denoted as (A1) through (A8), managing the first communication traffic flow according to one or more filtering rules may include one or more of (i) tagging the first communication traffic flow, (ii) redirecting the first communication traffic flow, (iii) mirroring the first communication traffic flow, (iv) storing the first communication traffic flow, and (v) copying the first communication traffic flow.

(A10) In any one of the methods denoted as (A1) through (A9), the gateway may perform network address translation (NAT).

(A11) In any one of the methods denoted as (A1) through (A10), the undesired communication traffic may be one or more of (i) distributed denial of service (DDoS) communication traffic and (ii) Command and Control (C2) communication traffic.

(A12) Any one of the methods denoted as (A1) through (A11) may further include, before comparing the traffic fingerprint to the connection log of the gateway, decrypting the traffic fingerprint.

(A13) In the method denoted as (A12), the traffic fingerprint may be encrypted using a public key of the gateway.

(A14) Any one of the methods denoted as (A1) through (A13) may further include adding in-band telemetry data to data packets of the first communication traffic flow to facilitate identification of the first communication traffic flow by one or more network elements upstream of the gateway.

(A15) In the method denoted as (A14), the in-band telemetry data may be configured to not identify the first client of the LAN, to protect privacy of the first client of the LAN.

(A16) In either one of the methods denoted as (A14) and (A15), the in-band telemetry data may include a hashed flag added to a P4 In-band Network Telemetry (INT) header.

(A17) Any one of the methods denoted as (A14) through (A16) may further include digitally signing the in-band telemetry data to enable the one or more network elements upstream of the gateway to verify authenticity of the in-band telemetry data.

(A18) Any one of methods denoted as (A1) through (A17) may further include receiving, from the management controller, the one or more filtering rules.

(B1) A method operable by a gateway for managing undesired communication traffic, where the gateway communicatively couples a LAN with a communication service provider's network, includes the following steps: (1) receiving a traffic fingerprint from a management controller, the traffic fingerprint representing one or more characteristics of the undesired communication traffic, (2) comparing the traffic fingerprint to each uplink data packet flowing through the gateway, and (3) managing each uplink data packet flowing through the gateway that matches the traffic fingerprint according to one or more filtering rules, without interfering with uplink data packets flowing through the gateway that do not match the traffic fingerprint.

(B2) In the method denoted as (B1), the traffic fingerprint may include one or more of (i) an identity of a source port of the undesired communication traffic, (ii) a type of the source port of the undesired communication traffic, (iii) an identity of a destination port of the undesired communication traffic, (iv) a type of the destination port of the undesired communication traffic, (v) payload data characteristics of the undesired communication traffic, and (vi) flow characteristics of the undesired communication traffic.

(B3) In either one of the methods denoted as (B1) and (B2), the traffic fingerprint may exclude an Internet Protocol (IP) address of a device receiving the undesired communication traffic, to preserve privacy of the device receiving the undesired communication traffic.

(B4) In any one of the methods denoted as (B1) through (B3), managing each uplink data packet flowing through the gateway that matches the traffic fingerprint according to one or more filtering rules may include configuring a firewall of the gateway to impede each uplink data packet flowing through the gateway that matches the traffic fingerprint.

(B5) In the method denoted as (B4), the gateway may impede each uplink data packet flowing through the gateway that matches the traffic fingerprint by one of (i) blocking each uplink data packet flowing through the gateway that matches the traffic fingerprint, (ii) black-holing each uplink data packet flowing through the gateway that matches the traffic fingerprint, and (iii) delaying each uplink data packet flowing through the gateway that matches the traffic fingerprint.

(B6) In any one of the methods denoted as (B1) through (B5), managing each uplink data packet flowing through the gateway that matches the traffic fingerprint according to one or more filtering rules may include one or more of (i) tagging each uplink data packet flowing through the gateway that matches the traffic fingerprint, (ii) redirecting each uplink data packet flowing through the gateway that matches the traffic fingerprint, (iii) mirroring each uplink data packet flowing through the gateway that matches the traffic fingerprint, (iv) storing each uplink data packet flowing through the gateway that matches the traffic fingerprint, and (v) copying each uplink data packet flowing through the gateway that matches the traffic fingerprint.

(C1) A method operable by a gateway for managing undesired communication traffic, where the gateway communicatively couples a LAN with a communication service provider's network, includes the following steps: (1) receiving a machine learning model from a management controller, (2) receiving, from the management controller, one or more updated weights for the machine learning model, (3) updating the machine learning model at least partially using the one or more updated weights, (4) after updating the machine learning model, using the machine learning model to classify communication traffic flowing through the gateway as either desired or undesired, and (5) managing communication traffic flowing through the gateway that is classified as undesired according to one or more filtering rules, without interfering communication traffic flowing through the gateway that is classified as desired.

(C2) In the method denoted as (C1), managing communication traffic flowing through the gateway that that is classified as undesired according to one or more filtering rules may include configuring a firewall of the gateway to impede communication traffic flowing through the gateway that is classified as undesired.

(C3) In the method denoted as (C2), the gateway may impede communication traffic flowing through the gateway that is classified as undesired by one of (i) blocking communication traffic flowing through the gateway that is classified as undesired, (ii) black-holing communication traffic flowing through the gateway that is classified as undesired, and (iii) delaying communication traffic flowing through the gateway that is classified as undesired.

(C4) In any one of the methods denoted as (C1) through (C3), managing communication traffic flowing through the gateway that is classified as undesired may include one or more of (i) tagging communication traffic flowing through the gateway that is classified as undesired, (ii) redirecting communication traffic flowing through the gateway that is classified as undesired, (iii) mirroring communication traffic flowing through the gateway that is classified as undesired, (iv) storing communication traffic flowing through the gateway that is classified as undesired, and (v) copying communication traffic flowing through the gateway that is classified as undesired.

(C5) In any one of the methods denoted as (C1) through (C4), the machine learning model may be further configured to classify communication traffic flowing through the gateway as either desired or undesired at least partially based on in-band telemetry data included in the communication traffic flowing through the gateway.

(D1) A method operable by a management controller for managing undesired communication traffic originating from a LAN, where the LAN is communicatively coupled to a communication service provider's network by a gateway, includes the following steps: (1) receiving metadata for the undesired communication traffic, (2) detecting communication traffic in the communication service provider's network matching the metadata, (3) determining that the gateway is a source of the communication traffic in the communication service provider's network matching the metadata, (4) in response to determining that the gateway is the source of the communication traffic in the communication service provider's network matching the metadata, generating a traffic fingerprint representing one or more characteristics of the communication traffic in the communication service provider's network matching the metadata, and (5) sending the traffic fingerprint to the gateway at least partially using the communication service provider's network.

(D2) The method denoted as (D1) may further include encrypting the traffic fingerprint using a public key of the gateway before sending the traffic fingerprint to the gateway.

(D3) In either one of the methods denoted as (D1) and (D2), the traffic fingerprint may include one or more of (i) an identity of a source port of the undesired communication traffic, (ii) a type of the source port of the undesired communication traffic, (iii) an identity of a destination port of the undesired communication traffic, (iv) a type of the destination port of the undesired communication traffic, (v) payload data characteristics of the undesired communication traffic, and (vi) flow characteristics of the undesired communication traffic.

(D4) In any one of the methods denoted as (D1) through (D3), the traffic fingerprint may exclude an Internet Protocol (IP) address of an external network element receiving the undesired communication traffic, to preserve privacy of the external network element.

(D5) In any one of the methods denoted as (D1) through (D4), (1) the metadata of the undesired communication traffic may include an Internet Protocol (IP) address of a source of the undesired communication traffic, and (2) determining that the gateway is the source of the communication traffic in the communication service provider's network matching the metadata may include matching the IP address included in the metadata with an IP address stored during subscription of the gateway to management service.

(D6) Any one of the methods denoted as (D1) through (D5) may further include tracking a subscription of the gateway to management service of the management controller by (i) an Internet Protocol (IP) address of the gateway and (ii) a public key of the gateway.

(D7) In any one of the methods denoted as (D1) through (D6), the undesired communication traffic may be one or more of (i) distributed denial of service (DDoS) communication traffic and (ii) Command and Control (C2) communication traffic.

(D8) In any one of the methods denoted as (D1) through (D7), detecting communication traffic in the communication service provider’s network matching the metadata may include matching one or more patterns included in the metadata with communication traffic in the communication service provider's network.

(D9) In the method denoted as (D8), matching the one or more patterns included in the metadata with communication traffic in the communication service provider's network may include determining that the one or more patterns included in the metadata match communication traffic in the communication service provider's network with a confidence level that is at least a predetermined minimum value.

(E1) A method operable by a controller for managing undesired communication traffic originating from a LAN, where the LAN is communicatively coupled to a communication service provider's network by a gateway, includes the following steps: (1) receiving metadata for the undesired communication traffic, (2) detecting communication traffic in the communication service provider's network matching the metadata, (3) determining that the gateway is a source of the communication traffic of the communication service provider's network matching the metadata, (4) in response to determining that the gateway is the source of communication traffic of the communication service provider's network matching the metadata, generating updated weights for a machine learning model of the gateway at least partially based on the metadata, the machine learning model of the gateway being capable of classifying communication traffic flowing through the gateway as either desired communication traffic or undesired communication traffic, and (5) sending the updated weights to the gateway at least partially using the communication service provider's network.

(E2) The method denoted as (E1) may further include encrypting the updated weights using a public key of the gateway before sending the updated weights to the gateway.

(E3) In either one of the methods denoted as (E1) and (E2), the undesired communication traffic may be one or more of (i) distributed denial of service (DDoS) communication traffic and (ii) Command and Control (C2) communication traffic.

(F1) A method operable by a first network element for managing undesired communication traffic includes the following steps: (1) receiving one or more data packets including first in-band telemetry data, (2) verifying authenticity of the first in-band telemetry data using a digital signature, and (3) managing the one or more data packets at the first network element in accordance with one or more filtering rules.

(F2) In the method denoted as (F1), the first in-band telemetry data may include a hashed flag added to a P4 In-band Network Telemetry (INT) header.

(F3) In either one of the methods denoted as (F1) and (F2), the first in-band telemetry data may indicate the one or more data packets are part of an undesired communication traffic flow.

(F4) In any one of the methods denoted as (F1) through (F3), managing the one or more data packets at the first network element in accordance with one or more filtering rules may include one or more of (i) impeding the one or more data packets, (ii) tagging the one or more data packets, (iii) redirecting the one or more data packets, (iv) mirroring the one or more data packets, (v) storing the one or more data packets, (vi) logging the one or more data packets, and (vii) copying the one or more data packets.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. A method operable by a gateway for managing undesired communication traffic, the gateway communicatively coupling a local area network (LAN) with a communication service provider’s network, the method comprising:
receiving a traffic fingerprint from a management controller, the traffic fingerprint representing one or more characteristics of the undesired communication traffic;
comparing the traffic fingerprint to a connection log of the gateway to determine that the undesired communication traffic corresponds to a first communication traffic flow, the first communication traffic flow being a communication traffic flow of a first client of the LAN that flows through the gateway; and
in response to determining that the undesired communication traffic corresponds to the first communication traffic flow, managing the first communication traffic flow according to one or more filtering rules without interfering with a second communication traffic flow, the second communication traffic flow being another communication traffic flow of the first client of the LAN that flows through the gateway.

2. The method of claim 1, wherein the traffic fingerprint includes (i) an identity of a source port of the undesired communication traffic, (ii) a type of the source port of the undesired communication traffic, (iii) an identity of a destination port of the undesired communication traffic, and (iv) a type of the destination port of the undesired communication traffic.

3. The method of claim 2, wherein the traffic fingerprint further includes a timestamp representing a time when the undesired communication traffic was detected.

4. The method of claim 1, wherein the traffic fingerprint includes one or more of (i) payload data characteristics of the undesired communication traffic and (ii) flow characteristics of the undesired communication traffic.

5. The method of claim 1, wherein managing the first communication traffic flow according to the one or more filtering rules comprises configuring a firewall of the gateway to impede the first communication traffic flow.

6. The method of claim 5, wherein the gateway impedes the first communication traffic flow by one of (i) blocking the first communication traffic flow, (iii) black-holing the first communication traffic flow, and (iii) delaying the first communication traffic flow.

7. The method of claim 1, wherein managing the first communication traffic flow according to the one or more filtering rules comprises one or more of (i) tagging the first communication traffic flow, (ii) redirecting the first communication traffic flow, (iii) mirroring the first communication traffic flow, (iv) storing the first communication traffic flow, and (v) copying the first communication traffic flow.

8. The method of claim 1, wherein the first communication traffic flow is one of distributed denial of service (DDoS) communication traffic and Command and Control (C2) communication traffic.

9. The method of claim 1, wherein:
the traffic fingerprint is encrypted using a public key of the gateway before the gateway receives the traffic fingerprint; and
the method further comprises decrypting the traffic fingerprint using a private key of the gateway before comparing the traffic fingerprint to the connection log of the gateway.

10. The method of claim 1, further comprising adding in-band telemetry data to data packets of the first communication traffic flow to facilitate identification of the first communication traffic flow by one or more network elements upstream of the gateway.

11. A method operable by a gateway for managing undesired communication traffic, the gateway communicatively coupling a local area network (LAN) with a communication service provider’s network, the method comprising:
receiving a traffic fingerprint from a management controller, the traffic fingerprint representing one or more characteristics of the undesired communication traffic;
comparing the traffic fingerprint to each uplink data packet flowing through the gateway; and
managing each uplink data packet flowing through the gateway that matches the traffic fingerprint according to one or more filtering rules, without interfering with uplink data packets flowing through the gateway that do not match the traffic fingerprint.

12. The method of claim 11, wherein the traffic fingerprint includes one or more of (i) an identity of a source port of the undesired communication traffic, (ii) a type of the source port of the undesired communication traffic, (iii) an identity of a destination port of the undesired communication traffic, (iv) a type of the destination port of the undesired communication traffic, (v) payload data characteristics of the undesired communication traffic, and (vi) flow characteristics of the undesired communication traffic.

13. The method of claim 11, wherein managing each uplink data packet flowing through the gateway that matches the traffic fingerprint according to one or more filtering rules comprises configuring a firewall of the gateway to impede each uplink data packet flowing through the gateway that matches the traffic fingerprint.

14. The method of claim 11, wherein managing each uplink data packet flowing through the gateway that matches the traffic fingerprint according to one or more filtering rules comprises one or more of (i) tagging each uplink data packet flowing through the gateway that matches the traffic fingerprint, (ii) redirecting each uplink data packet flowing through the gateway that matches the traffic fingerprint, (iii) mirroring each uplink data packet flowing through the gateway that matches the traffic fingerprint, (iv) storing each uplink data packet flowing through the gateway that matches the traffic fingerprint, and (v) copying each uplink data packet flowing through the gateway that matches the traffic fingerprint.

15. A method operable by a management controller for managing undesired communication traffic originating from a local area network (LAN), the LAN being communicatively coupled to a communication service provider’s network by a gateway, the method comprising:
receiving metadata for the undesired communication traffic;
detecting communication traffic in the communication service provider’s network matching the metadata;
determining that the gateway is a source of the communication traffic in the communication service provider’s network matching the metadata;
in response to determining that the gateway is the source of the communication traffic in the communication service provider’s network matching the metadata, generating a traffic fingerprint representing one or more characteristics of the communication traffic in the communication service provider’s network matching the metadata; and
sending the traffic fingerprint to the gateway at least partially using the communication service provider’s network.

16. The method of claim 15, further comprising encrypting the traffic fingerprint using a public key of the gateway before sending the traffic fingerprint to the gateway.

17. The method of claim 15, wherein the traffic fingerprint includes one or more of (i) an identity of a source port of the undesired communication traffic, (ii) a type of the source port of the undesired communication traffic, (iii) an identity of a destination port of the undesired communication traffic, (iv) a type of the destination port of the undesired communication traffic, (v) payload data characteristics of the undesired communication traffic, and (vi) flow characteristics of the undesired communication traffic.

18. The method of claim 15, wherein:
the metadata of the undesired communication traffic includes an Internet Protocol (IP) address of a source of the undesired communication traffic; and
determining that the gateway is the source of the communication traffic in the communication service provider’s network matching the metadata comprises matching the IP address included in the metadata with an IP address stored during subscription of the gateway to management service.

19. The method of claim 15, further comprising tracking a subscription of the gateway to management service of the management controller by (i) an Internet Protocol (IP) address of the gateway and (ii) a public key of the gateway.

20. The method of claim 15, wherein the undesired communication traffic is one or more of (i) distributed denial of service (DDoS) communication traffic and (ii) Command and Control (C2) communication traffic.
